(19) United States
(12) Patent Application Publication
(10) Pub. No.: US 2009/0250859 A1
(43) Pub. Date: Oct. 8, 2009

(54) Method and Device for Manufacture of Connecting Rod

(75) Inventors: Hideki Okumura, Ibaraki-ken (JP); Tsuguo Koguchi, Tochigi-ken (JP); Masao Kumagai, Tochigi-ken (JP); Tomoyuki Shiga, Tochigi-ken (JP); Yuukou Hashimoto, Tochigi-ken (JP); Yoshiaki Yanata, Tochigi-ken (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Honda Motor Co., Ltd.

(21) Appl. No.: 12/084,544

(22) PCT Filed: Nov. 8, 2006
(86) PCT No.: PCT/JP2006/322300

§ 371 Date: May 5, 2008

(30) Foreign Application Priority Data
Nov. 9, 2005 (JP) 2005-325200
Dec. 1, 2005 (JP) 2005-348465
Dec. 1, 2005 (JP) 2005-348470
Mar. 14, 2006 (JP) 2006-069971

(51) Int. Cl. B25B 1/22; B21D 53/84

(52) U.S. Cl. 269/74; 29/888.09

(57) ABSTRACT

A device for manufacturing a connecting rod comprises a fixed stage secured onto a base, a movable stage so installed as to be move close to and apart from the fixed stage, and a set of backup cylinders displacing the overall movable stage along the axial direction of the connecting rod. The set of backup cylinders are substantially simultaneously biased to displace a cap part together with the movable stage until the fractured surface of the cap part of the connecting rod abuts on the fractured surface of the rod part of the connecting rod held on the fixed stage. Consequently, the removal and release of chips produced on the mating fractured surfaces can be promoted.

### TECHNICAL FIELD

The present invention relates to a method of and an apparatus (device) for manufacturing a connecting rod as an engine component for vehicles, and more particularly to a method of and an apparatus for manufacturing a connecting rod by integrally forming a connecting rod having a larger end and a smaller end, cracking the larger end into a cap part and a rod part, and coupling the cap part and the rod part to each other with a pair of bolts by managing fastening forces of the bolts.

### BACKGROUND ART

Connecting rods which connect piston pins and crankpins are widely employed in engines for vehicles. A connecting rod has a larger end connected to the crankpin and a smaller end connected to the piston pin. For manufacturing a connecting rod, it is customary to integrally form a connecting rod from the larger end to the smaller end by forging or the like, for example, and then crack the larger end into a cap part and a rod part.

As shown in FIGS. 27 and 28 of the accompanying drawings, a connecting rod 1 is manufactured by integrally forging a workpiece including a rod part 6 and a cap part 7 which are integrally combined with each other, cracking the workpiece into the rod part 6 and the cap part 7 along grooves C, and then firmly coupling the rod part 6 and the cap part 7 with a pair of bolts 9a, 9b threaded into bolt holes 8.

The connecting rod 1 has a smaller end 4 with a first small-diameter through hole 2 defined therein, and a larger end 5 positioned remotely from the smaller end 4 along the axis of the connecting rod 1, the larger end 5 having a second through hole 3 defined therein which is greater in diameter than the first through hole 2.

The larger end 5 of the connecting rod 1 is cracked substantially centrally across the second through hole 3 along the groove C in a direction (indicated by the arrow Y in FIG. 27) perpendicular to the longitudinal direction (indicated by the arrow X) of the connecting rod 1, separating the connecting rod 1 into the rod part 6 and the cap part 7. The rod part 6 has fractured surfaces along the groove C and the cap part 7 also has fractured surfaces along the groove C. Since these fractured surfaces are complementary mating surfaces, when the rod part 6 and the cap part 7 are fastened to each other by bolts 9a, 9b, the fractured surfaces of the rod part 6 and the fractured surfaces of the cap part 7 are neatly held in close contact with each other, so that the rod part 6 and the cap part 7 can be assembled highly accurately with each other.

The rod part 6 and the cap part 7 are connected to each other by inserting the bolts 9a, 9b into the bolt holes 8 to bring internally threaded surfaces of the bolt holes 8 and externally threaded surfaces of the bolts 9a, 9b into threaded fitting engagement with each other.

The bolt holes 8 are formed simultaneously in the rod part 6 and the cap part 7 because the bolt holes 8 are formed before the larger end 5 is cracked. Therefore, the bolt holes 8 do not need to be formed individually in the rod part 6 and the cap part 7, and the mating surfaces of the rod part 6 and the cap part 7 do not need to be machined to a flat finish.

A method of cracking a connecting rod disclosed in Japanese Laid-Open Patent Publication No. 10-277848, for example, comprises the steps of providing an internal pressure applying device for applying an outward internal pressure to a bearing hole in the bearing of a connecting rod and a pair of external pressure applying devices for applying an external pressure to the bearing, applying an external pressure to the bearing from the pair of external pressure applying devices and an internal pressure to the bearing from the internal pressure applying device, and instantaneously releasing the external pressure from the external pressure applying devices while the internal pressure to the bearing from the internal pressure applying device is of a level capable of cracking the bearing, thereby enabling the internal pressure to instantaneously crack the bearing.

Japanese Laid-Open Patent Publication No. 2002-066998 discloses an apparatus for fracturing a connecting rod, comprising first and second support members for horizontally supporting a connecting rod, the first and second support members being disposed on a base of a pallet for placing the connecting rod thereon and movable in directions away from each other, a split mandrel having mandrel halves vertically mounted on the first and second support members and having respective outer circumferential surfaces for abutment against respective inner surfaces of an opening part, a wedge having tapered surfaces abutting against confronting end surfaces of the mandrel halves, for uniformly separating and spreading the mandrel halves away from each other, an actuator for applying a load to the wedge, and a control circuit for applying an initial load to the actuator to bring the mandrel halves into abutment against the respective inner surfaces of the opening part and thereafter applying a fracture load to instantaneously fracturing the opening part.

Japanese Laid-Open Patent Publication No. 06-042527, for example, reveals an apparatus for cracking a connecting rod by equally applying breaking forces in directions to separate a pair of semi-cylindrical protrusions away from each other, to axially opposite sides of the semi-cylindrical protrusions which are fitted in a hole defined in a larger end of a connecting rod, thereby preventing the hole in the cracked larger end from being distorted.

Japanese Laid-Open Patent Publication No. 64-064729 discloses a method of forming a pair of recesses in the inner circumferential surface of a hole in a larger end of a connecting rod, and cracking the connecting rod along a fracture plane based on the recesses, into a cap part and a rod part.

Japanese Laid-Open Patent Publication No. 2003-512522 (PCT) discloses a process for preventing sticky material particles that can be removed from unnecessarily falling off the fracture surfaces. According to the disclosed process, after a connecting rod is fractured into a rod part and a cap part, bolts are mounted on the rod part and the cap part, and then loosened. After the parts are vibrated at a predetermined frequency, the bolts are tightened.

According to the cracking method disclosed in Japanese Laid-Open Patent Publication No. 10-277848, it is difficult to control the timing to detect a cracking internal pressure and instantaneously release the external pressure from the external pressure applying devices, because of variations due to manufacturing errors of the connecting rod.

The fracturing apparatus disclosed in Japanese Laid-Open Patent Publication No. 2002-066998 tends to fail to fully restrain horizontal oscillations that occur when the larger end is fractured into the cap part and the rod part.

It is difficult to shorten the time lag between a prior fracture on one of the left and right cracking regions and a subsequent fracture on the other.

Connecting rods are classified into the crackable connecting rod described above and an assembled connecting rod. The assembled connecting rod is manufactured by individually producing a rod part and a cap part and then integrally coupling the rod part and the cap part with a pair of bolts (see Japanese Laid-Open Patent Publication No. 11-002230).

The assembled connecting rod is manufactured by individually producing a rod part and a cap part of a larger end and then integrally assembling the rod and the cap with a pair of bolts. The cap part is positioned highly accurately with respect to the rod part by positioning pins that are fitted respectively in a pin hole in the rod part and a pin hole in the cap part.

However, after the rod part and the cap part are individually forged, it is necessary to form bolt holes in the rod part and the cap part, and then to machine mating surfaces of the rod part and the cap part to a flat finish. Therefore, the number of man-hours required to produce the assembled connecting rod is large, presenting an obstacle to efforts to increase the production efficiency.

The crackable connecting rod does not employ positioning pins used on the assembled connecting rod. When the cracked complementary mating surfaces of the rod part and the cap part are held against each other, it is necessary to bring the mating surfaces into accurately mating engagement with each other.

When the rod part and the cap part are integrally combined with each other, if the configurations of the cracked complementary mating surfaces of the rod part and the cap part are broken, then the mating surfaces fail to provide a positioning function, and extra gaps are created between the rod part and the cap part. As a result, noise may be generated and the circularity of the hole in the larger end may be adversely affected.

When a connecting rod is cracked into a cap part and a rod part, the rod part and the cap part will shrink due to residual stresses developed after the cracking. On account of the shrinkage, the reunited region where the fractured surface of the cap part and the fractured surface of the rod part are joined to each other comprises a step produced by irregular surfaces, not flat surfaces, mating with each other. The cap part and the rod part may be extended (enlarged), rather than shrink, due to residual stresses developed after the cracking.

Because each of the rod part and the cap part shrinks due to residual stresses developed after the cracking (generally, the cap part shrinks greater than the rod part), when the fractured surface of the cap and the fractured surface of the rod part are brought into mating engagement with other, they are positionally displaced and are unable to mate accurately with each other owing to the shrinkage.

An attempt has been made to form a pair of cross-sectionally V-shaped notches in to-be-cracked regions of the inner circumferential surface of a larger end of a connecting rod. When the larger end is cracked from the cross-sectionally V-shaped notches, the crack (main crack) progresses as it propagates due to a brittle fracture, and the crack (main crack) branches into small auxiliary cracks while the crack is propagating. When the connecting rod is assembled into an internal combustion engine or when the internal combustion engine with the assembled connecting rod operates, the auxiliary cracks tend to propagate themselves, producing a fragment which tends to come off to leave a small space in the larger end.

When the rod part and the cap part are integrally combined with each other, if the configurations of the cracked complementary mating surfaces of the rod part and the cap part are broken, then the mating surfaces fail to provide a positioning function, and extra gaps are created between the rod part and the cap part. As a result, noise may be generated and the circularity of the hole in the larger end may be adversely affected.

### DISCLOSURE OF THE INVENTION

It is a general object of the present invention to provide a method of and an apparatus for manufacturing a connecting rod by cracking the connecting rod into a cap part and a rod part and immediately thereafter bringing the fractured surfaces of the cap part and the rod part into abutment against each other for thereby promoting removal or separation of defective regions developed in the cracked mating surfaces.

A major object of the present invention is to provide a method of and an apparatus for manufacturing a connecting rod by managing tightening forces of a pair of bolts to fasten a cap part and a rod part to each other for thereby accurately joining the cap and the rod which have shrunk when the connecting rod was cracked into the cap part and the rod part.

Another object of the present invention is to provide a method of and an apparatus for manufacturing a connecting rod by managing tightening forces of a pair of bolts to fasten a cap part and a rod part to each other for thereby promoting removal or separation of defective regions developed in the cracked mating surfaces.

According to the present invention, first, by a workpiece positioning and holding mechanism, a rod part of a connecting rod is set on a fixed stage, and a cap part of the connecting rod is set on a movable stage which is movable with respect to the fixed stage.

Subsequently, the set cap part of the connecting rod is pressed toward a smaller end with a first support mechanism to laterally support shoulders of the cap part. Also, a second support mechanism is actuated to press the first support mechanism toward the cap part thereby to secure the cap part between the first support mechanism and the spreader which is positioned near the cap part.

Next, a loading mechanism is actuated to apply a load for cracking the larger end into the cap part and the rod part while the cap part is being displaced in unison with the movable stage with the cap part being secured between the first support mechanism and the spreader which is positioned near the cap part.

After the larger end is cracked into the cap part and the rod part, a fragment removing/release promoting mechanism is actuated for displacing the movable stage toward the fixed stage while the cap part and the rod part are being held respectively on the movable stage and the fixed stage. Since a fractured surface of the cap part and a fractured surface of the rod part are brought into contact with each other, removal of fragments produced in the fractured surfaces of the cap part and the rod part can be promoted, or release of fragments produced in the fractured surfaces can be promoted. After the fractured surface of the cap part and the fractured surface of the rod part are brought into contact with each other, a thrust force applied to the fractured surfaces is changed to an increased level, thereby being capable of preferably promoting the removal of the fragments or the release of the fragments produced in the fractured surfaces.

Thus, according to the present invention, immediately after the connecting rod is cracked into the cap part and the rod part, the cap part and the rod part are brought into contact with each other while the cap part and the rod part are being held respectively on the movable stage and the fixed stage. Therefore, fragments can be smoothly removed, or release of the fragments can be promoted.

Further, according to the present invention, the cracked cap part and the cracked rod part are fastened together with a pair of the bolts as follows. First, the pair of the bolts are tightened by being turned at a predetermined speed, bringing the fractured surface of the cap part and the fractured surface of the rod part toward each other. The fractured surface of the cap part and the fractured surface of the rod part are held in contact with each other when the surface irregularities of the fractured surfaces of the cap part and the rod part are complementarily combined with each other. At this time, a positional misalignment between the fractured surfaces due to the shrinkage of the cap part at the time cracking is corrected. When the tightening torque of the pair of the bolts reaches the preset torque, the bolts are stopped and kept in a standby state.

The temporary tightening torque is preset based on experimental data produced by measuring, with a torque wrench, the maximum torque of the pair of the bolts that are manually tightened by worker's fingers, for example. The temporary tightening torque may be set variously, depending on the type, size and the like of the connecting rod.

In the present invention, times to tighten the pair of the bolts are not equalized, but tightening processes for the respective bolts are equalized from the time when the tightening torque of the bolts reaches the temporary tightening torque. That is, the tightening processes for the respective bolts are equalized from the time when the fractured surface of the cap part and the fractured surface of the rod part are brought into contact with each other such that irregularities of the fractured surface of the cap part and the fractured surface of the rod part are complementarily aligned with each other, and a positional misalignment between the fractured surfaces due to the shrinkage of the cap part at the time the connecting rod is cracked is corrected. Then, the pair of the bolts are tightened in synchronism with each other until the tightening torque of the bolts reaches a predetermined torque which is greater than the temporary tightening torque.

Subsequently, the pair of bolts are loosened, and the removal of the fragments produced in the mating fractured surfaces of the cap part and the rod part or the release of fragments produced in the mating fractured surfaces is promoted.

The fragments may be removed or the release of the fragments may be promoted, for example, by brushing the respective fractured surfaces of the cap part and the rod part.

According to the present invention, by managing tightening forces of the pair of bolts to fasten the cap part and the rod part to each other, the cap part and the rod part, which have shrunk when the connecting rod was cracked into the cap part and the rod part, can be accurately joined. Also, removal or separation of the fragments produced in the cracked mating surfaces can be promoted smoothly.

### BRIEF DESCRIPTION OF THE DRAWINGS

FIG. 1A is a perspective view of a connecting rod to which the present invention is applicable;

FIG. 1B is a perspective view of the connecting rod shown in FIG. 1A, which has been cracked into a cap part and a rod part;

FIG. 2 is an exploded perspective view of a cracking apparatus for carrying out a method of manufacturing a connecting rod according to an embodiment of the present invention;

FIG. 3 is a plan view, partly in cross section, of the cracking apparatus shown in FIG. 2;

FIG. 4 is a vertical cross-sectional view of the cracking apparatus shown in FIG. 2 taken along an axial direction thereof;

FIG. 5 is an enlarged fragmentary perspective view of the cracking apparatus shown in FIG. 2;

FIG. 6 is an enlarged fragmentary vertical cross-sectional view of the cracking apparatus shown in FIG. 4;

FIG. 7 is a front elevational view, partly in cross section, showing the manner in which a preload is applied by a preload applying mechanism of the cracking apparatus;

FIG. 8 is a front elevational view, partly in cross section, showing the manner in which an impact load is applied by the preload applying mechanism;

FIG. 9 is an enlarged fragmentary perspective view showing the manner in which a connecting rod is fractured into a cap part and a rod part;

FIG. 10 is an enlarged fragmentary perspective view showing the manner in which the connecting rod is fractured into the cap and the rod;

FIG. 11 is a flowchart of an operation sequence of the cracking apparatus shown in FIG. 2;

FIG. 12 is an enlarged fragmentary perspective view showing the manner in which a fractured surface of the cap part and a fractured surface of the rod part are pressed against each other;

FIGS. 13A through 13C are enlarged partial front elevational views showing progressive steps in which a crack develops into auxiliary cracks, which are propagated to produce a fragment that comes off;

FIG. 14 is a plan view of a connecting rod, illustrative of how the connecting rod is adversely affected by the time lag between a prior fracture and a subsequent fracture when the connecting rod is fractured into a cap part and a rod part;

FIG. 15 is a vertical cross-sectional view of a cracking apparatus according to another embodiment of the present invention;

FIG. 16 is a flowchart of an operation sequence of the cracking apparatus shown in FIG. 15;

FIG. 17 is a schematic perspective view of a joining apparatus for carrying out the method of manufacturing a connecting rod according to the present invention;

FIG. 18 is a perspective view of a positioning device incorporated in the joining apparatus shown in FIG. 17;

FIG. 19 is a side elevational view, partly in cross section, of the positioning device shown in FIG. 18;

FIG. 20 is a plan view of the positioning device shown in FIG. 18;

FIG. 21 is a side elevational view, partly in cross section, of a portion of the joining apparatus shown in FIG. 17 which includes a nut runner;

FIG. 22 is a plan view of the portion of the joining apparatus shown in FIG. 17 which includes the nut runner;

FIG. 23 is a flowchart showing tightening conditions for a pair of bolts for coupling a cap part and a rod part which have been fractured from each other;

FIG. 24A is a diagram showing the relationship between the dimension of the step between the cap part and the rod part at left fractured surfaces that mate with each other;

FIG. 24B is a diagram showing the relationship between the dimension of the step between the cap part and the rod part at right fractured surfaces that mate with each other;

FIG. 25 is a flowchart showing tightening conditions according to another embodiment for a pair of bolts for coupling a cap part and a rod part which have been fractured from each other;

FIG. 26 is a plan view showing the manner in which fractured surfaces of a cap part and a rod part which have been fractured from each other are brushed by respective brushes;

FIG. 27 is a perspective view of a cap part and a rod part which have been produced by cracking a connecting rod, before the cap part and the rod part are joined to each other by a pair of bolts; and

FIG. 28 is a perspective view of the cap part and the rod part which have been joined to each other by tightening the bolts.

### BEST MODE FOR CARRYING OUT THE INVENTION

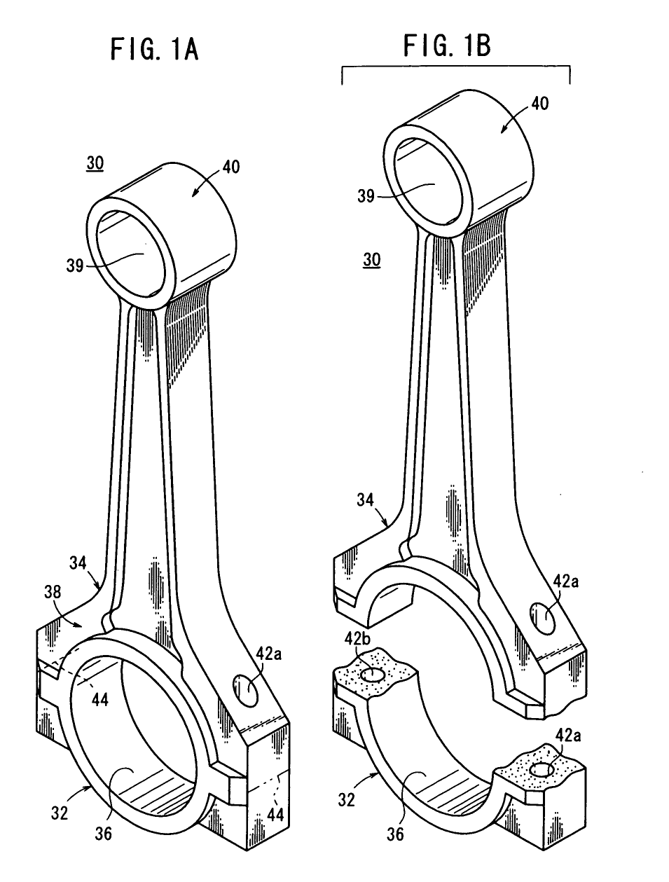

FIG. 1A is a perspective view of a connecting rod 30 as a workpiece to which the present invention is applicable, and FIG. 1B is a perspective view of the connecting rod 30, which has been cracked into a cap part 32 and a rod part 34.

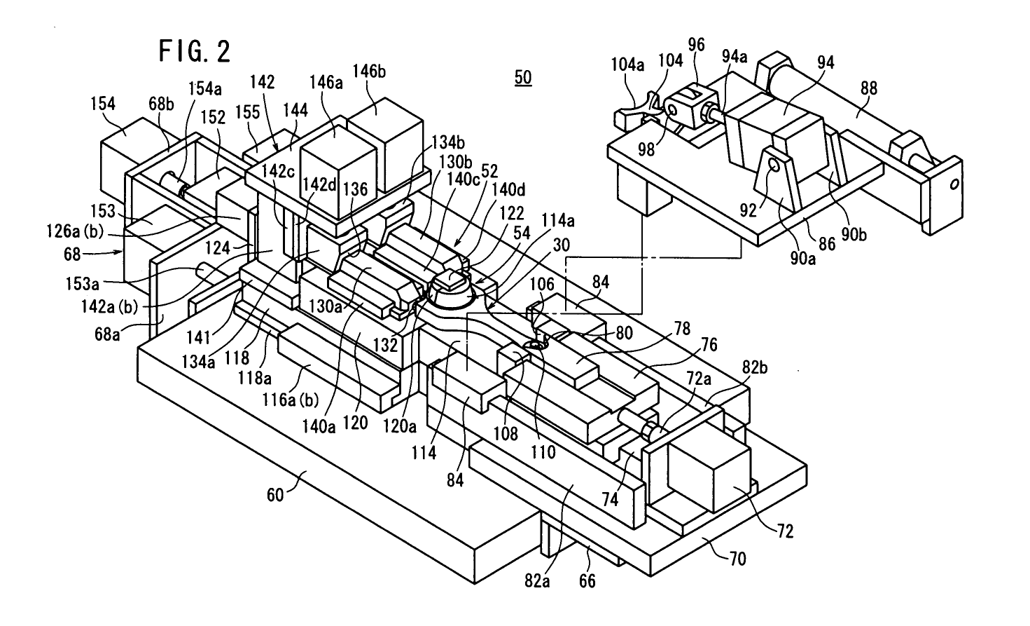

As shown in FIGS. 1A and 2B, the connecting rod 30 has a larger end 38 including a cap part 32 an a rod part 34 which are integrally united across a substantially circular joint hole 36, and a smaller end 40 positioned at an end of the rod part 34 remotely from the larger end 38 and having a small through hole 39 defined therein. The connecting rod 30 is integrally formed by casting or forging, for example.

The larger end 38 has a pair of bolt holes 42a, 42b defined therein on both sides of the joint hole 36 by a boring mechanism such as a drill or the like. In a process of assembling an engine, for example, bolts 9a, 9b, to be described later, are threaded respectively into the bolt holes 42a, 42b from the cap part 32 side, thereby fastening the cap part 32 to the rod part 34. When the cap part 32 and the rod part 34 are thus joined to each other, the larger end 38 is connected to a crankpin of the engine.

In FIG. 1A, cracking regions 44 where the larger end 38 will be cracked into the cap part 32 and the rod part 34 are positioned at a boundary between the cap part 32 and the rod part 34. The cracking regions 44 are disposed on both side of the larger end 38 centrally across the joint hole 36.

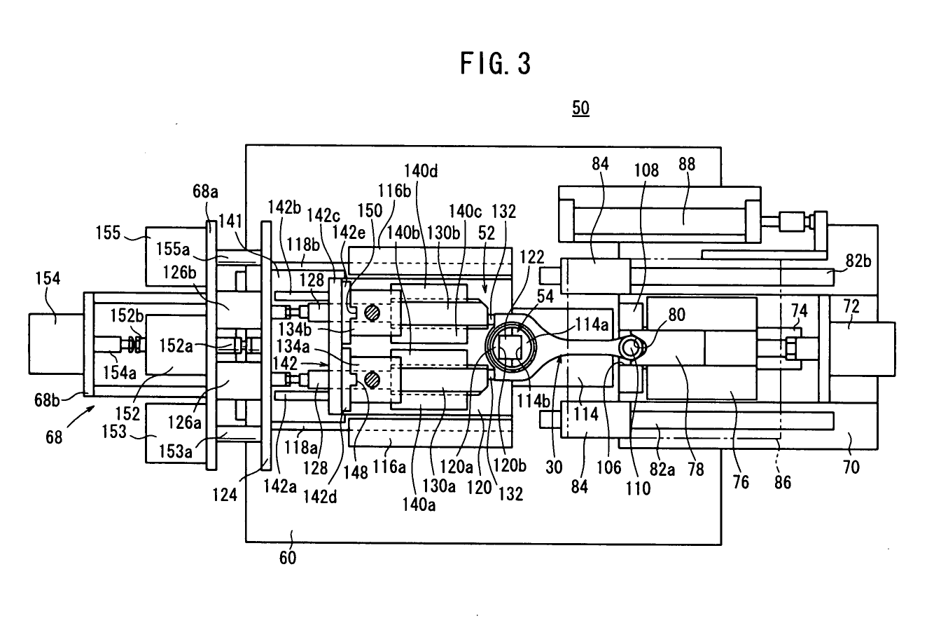

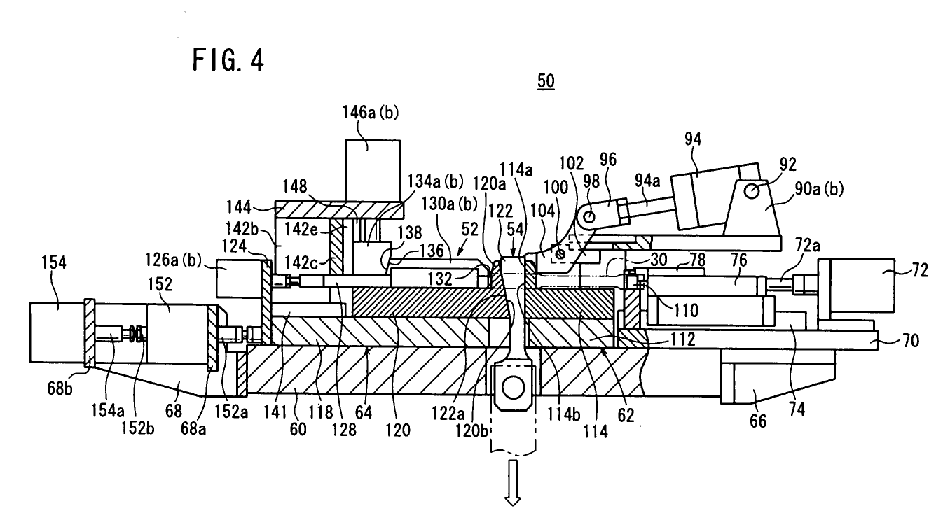

A cracking apparatus 50 for carrying out a method of manufacturing a connecting rod according to an embodiment of the present invention is shown in FIGS. 2 through 4. FIG. 2 is an exploded perspective view of the cracking apparatus 50. FIG. 3 is a plan view, partly in cross section, of the cracking apparatus 50. FIG. 4 is a vertical cross-sectional view of the cracking apparatus 50 taken along an axial direction thereof.

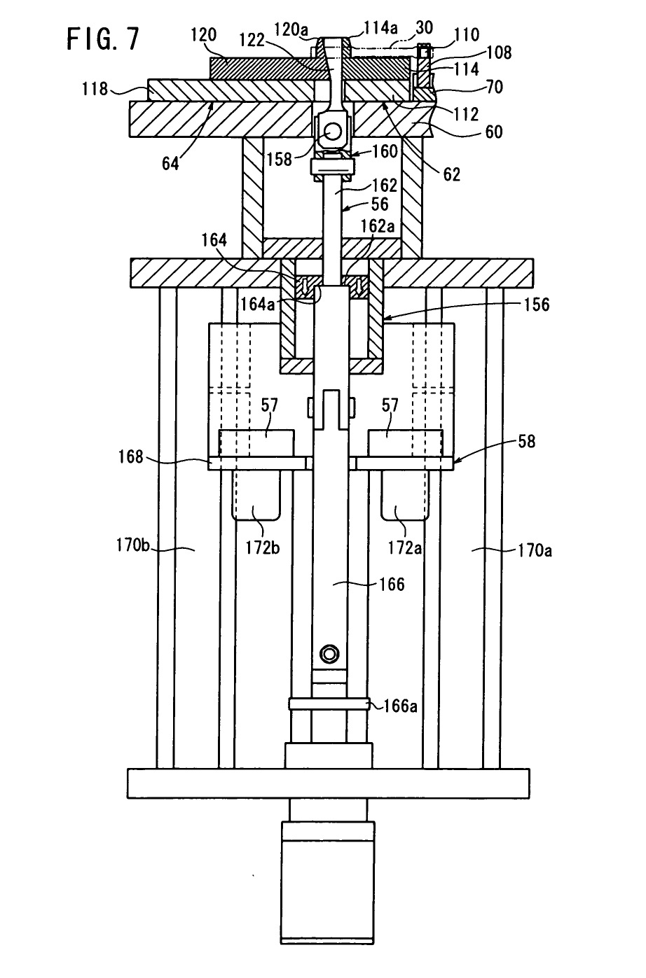

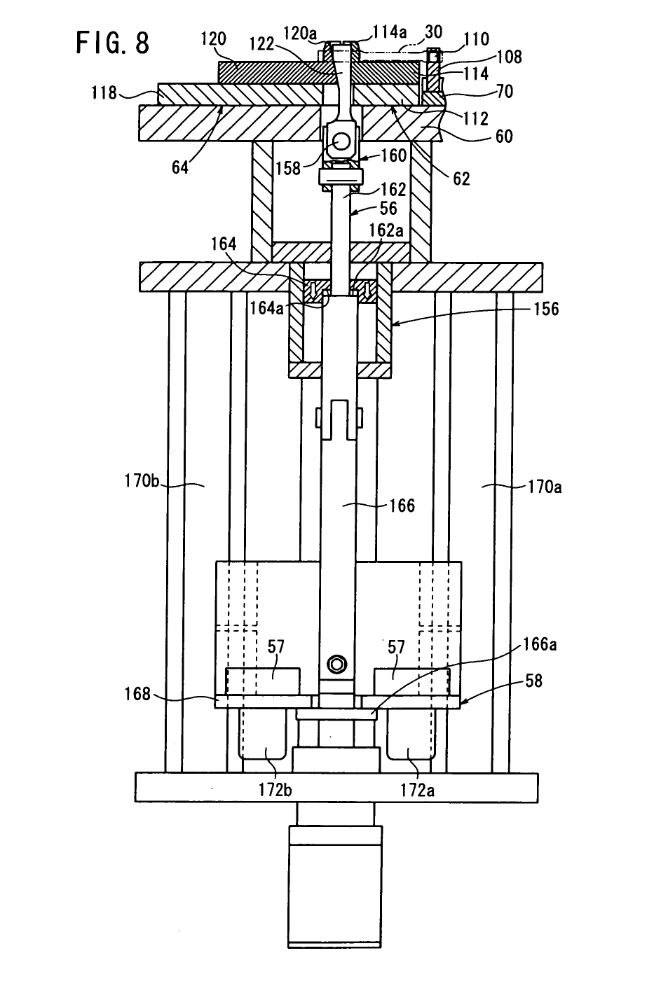

The cracking apparatus 50 comprises a workpiece positioning and holding mechanism 52 for setting the connecting rod 30 positioned at a predetermined position and holding the connecting rod 30 thus set, a cracking mechanism 54 for cracking the larger end 38 of the connecting rod 30, a preload applying mechanism 56 (see FIGS. 7 and 8) for applying a preload to the cracking mechanism 54, and a loading mechanism 58 (see FIGS. 7 and 8) for applying an impact load to the cracking mechanism 54 by dropping weights 57.

The workpiece positioning and holding mechanism 52 comprises a base 60 which is of a substantially elongate rectangular shape as viewed in plan, a fixed stage 62 fixedly mounted on the base 60, a movable stage 64 disposed in confronting relation to the fixed stage 62 and movable toward and away from the fixed stage 62 horizontally in the axial directions of the base 60, and first and second brackets 66, 68 secured respectively to the opposite ends of the base 60 and projecting outwardly in the axial directions of the base 60.

The fixed stage 62 includes a fixed table 70 fixed to the base 60 by the first bracket 66, a first oil cylinder 72 secured to the fixed table 70, a movable block 76 coupled to the distal end of a piston rod 72a of the first oil cylinder 72 and movable along a guide rail 74 back and forth in the axial directions of the connecting rod 30, and a first workpiece support member 78 secured in a groove defined in the movable block 76 and projecting a predetermined distance from an end of the movable block 76, the first workpiece support member 78 being movable by the first oil cylinder 72 to engage the smaller end 40 of the connecting rod 30 and push the smaller end 40 toward the larger end 38 in the axial direction of the connecting rod 30.

The pressure of oil supplied to the first oil cylinder 72 can be changed between high and low levels by a switching valve (not shown) to change forces (thrust forces) with which to push the smaller end 40 toward the larger end 38 in the axial direction of the connecting rod 30.

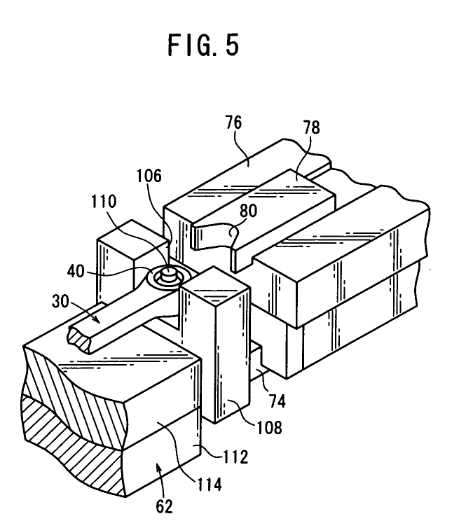

As shown in FIGS. 2 and 5, the first workpiece support member 78 has a tapered engaging slot 80 of V-shaped cross section defined in the distal end thereof for engaging the smaller end 40 of the connecting rod 30.

The fixed stage 62 also has a pair of guide members 82a, 82b fixedly mounted on the fixed table 70 substantially parallel to each other with the movable block 76 disposed therebetween, a slider 86 movable toward and away from the connecting rod 30 on a pair of guide blocks 84 slidable along the respective guide members 82a, 82b, and a first air cylinder 88 fixedly mounted on the fixed table 70 for moving the slider 86 toward and away from the connecting rod 30.

On the slider 86, there are mounted a second air cylinder 94 angularly movable through a predetermined angle about a first pin 92 pivotally attached to a pair of bearing blocks 90a, 90b on the slider 86, a joint member 96 having a bifurcated end and coupled to a piston rod 94a of the second air cylinder 94, and a second workpiece support member 104 having an end pivotally attached to the bifurcated end of the joint member 96 by a second pin 98 and a central portion pivotally supported on a joint plate 102 of the slider 86 by a third pin 100.

The second workpiece support member 104 has a substantially Y-shaped presser 104a on its distal end. When the second air cylinder 94 is actuated, the presser 104a is angularly moved (turned) a predetermined angle about the third pin 100 to press downwardly an upper surface of the larger end 38 (the rod part 34) of the connecting rod 30 for thereby holding the connecting rod 30.

As shown in FIG. 5, a bifurcated fixed block 108 projecting upwardly with a recess 106 of substantially rectangular cross section defined in its upper surface is fixedly mounted on the base 60 near the fixed table 70. A positioning and fixing pin 110 is disposed in the recess 106 for extending through the hole in the smaller end 40 and positioning and holding the smaller end 40.

When the first workpiece support member 78 is brought horizontally into the recess 106 in the fixed block 108, the engaging slot 80 in the distal end of the first workpiece support member 78 reliably engages the smaller end 40 while the first workpiece support member 78 and the connecting rod 30 are being held in axial alignment with each other.

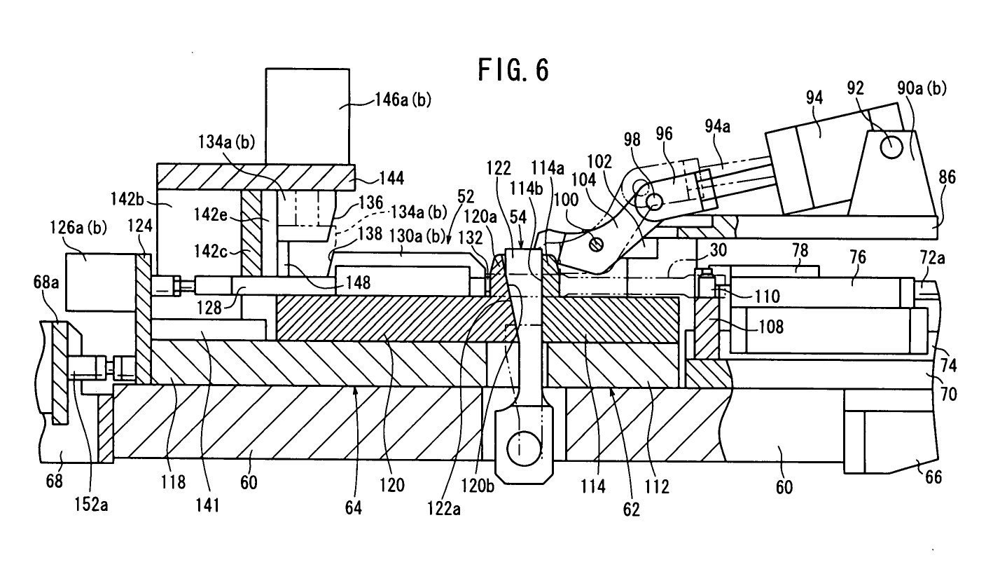

As shown in FIGS. 4 and 6, a holder block 112 fixedly mounted on the base 60 is disposed between the fixed block 108 and the movable stage 64. A first mandrel 114 having a semicircular protrusion 114a for contacting an edge of the joint hole 36 in the larger end 38 is fixedly mounted on the holder block 112.

As shown in FIGS. 2 and 3, a pair of first guide elements 116a, 116b are disposed substantially parallel to each other for guiding the movable stage 64 in the axial direction of the connecting rod 30. The first guide elements 116a, 116b have axially extending long grooves, respectively, defined therein over the upper surface of the base 60. A slide block 118 has a pair of flanges 118a, 118b on its opposite side edges which are slidably disposed in the respective grooves of the first guide elements 116a, 116b.

As shown in FIGS. 4 and 6, a second mandrel 120 having a semicircular protrusion 120a for contacting an edge of the joint hole 36 in the larger end 38 is fixedly mounted on an upper surface of the slide block 118. When the second mandrel 120 is displaced in unison with the movable stage 64, the second mandrel 120 moves a predetermined distance toward or away from the first mandrel 114 on the fixed stage 62. The semicircular protrusions 114a, 120a of the first and second mandrels 114, 120 function as a pair of spreaders.

The semicircular protrusions 114a, 120a have recesses 114b, 120b of rectangular cross section defined in respective mating surfaces thereof. When the recesses 114b, 120b are combined with each other, they jointly form a vertical through hole between the semicircular protrusions 114a, 120a. A wedge 122 of rectangular cross section engages in the vertical through hole. At this time, the semicircular protrusions 114a, 120a of the first and second mandrels 114, 120 are combined with each other, providing a circular boss. The circular boss is placed in the joint hole 36 in the larger end 38 of the connecting rod 30.

A connecting plate 124 which extends vertically is fixed to an end of the sliding block 118. The connecting plate 124 supports on its surface a pair of third air cylinders 126a, 126b horizontally spaced a predetermined distance from each other (see FIG. 3). The third air cylinders 126a, 126b have respective piston rods connected by respective shafts 128 to a pair of third workpiece support members (a first support mechanism) 130a, 130b. The third workpiece support members 130a, 130b are movable back and forth on an upper flat surface of the second mandrel 120 in the axial directions of the connecting rod 30 by the respective third air cylinders 126a, 126b.

A pair of teeth 132 is mounted on axial ends of the respective third workpiece support members 130a, 130b. The teeth 132 serve to abut against the cap part 32 of the larger end 38 of the connecting rod 30 and press the connecting rod 30 parallel to its axis in a direction from the larger end 38 toward the smaller end 40. The third workpiece support members 130a, 130b have respective slanted surfaces 138 on the other ends thereof remote from the teeth 132. The slanted surfaces 138 serve to engage pressing surfaces 136 of respective fourth workpiece support members 134a, 134b.

As shown in FIGS. 2 and 3, the third workpiece support members 130a, 130b are guided by two pairs of substantially parallel second guide elements 140a through 140d fixedly mounted on the upper flat surface of the second mandrel 120 for linear displacement in the axial directions of the connecting rod 30.

A secure plate 141 is mounted on the upper surface of the slide block 118. A pair of second oil cylinders (a second support mechanism) 146a, 146b is fixedly supported on an upper plate 144 that is mounted on the secure plate 141 by a support assembly 142 (see FIG. 2). The second oil cylinders 146a, 146b have respective vertical piston rods whose distal ends are coupled to respective fourth workpiece support members 134a, 134b each in the form of a substantially cubic block. The fourth workpiece support members 134a, 134b are vertically displaceable by the second oil cylinders 146a, 146b.

The pressure of oil supplied to the second oil cylinders 146a, 146b can be changed between high and low levels by a switching valve (not shown) to change forces (thrust forces) with which to push the third workpiece support members 130a, 130b toward the cap part 32 of the connecting rod 30.

One surface of each of the fourth workpiece support members 134a, 134b is formed as the pressing surface 136, for engaging the slanted surface 138 of each of the third workpiece support members 130a, 130b and pushing the third workpiece support members 130a, 130b toward the connecting rod 30.

As shown in FIG. 3, the support assembly 142 comprises a pair of first support plates 142a, 142b vertically fixed to an upper surface of the secure plate 141 and spaced from each other by a predetermined distance, the first support plates 142a, 142b extending substantially parallel to the axial directions of the connecting rod 30, a second support plate 142c extending substantially horizontally and joined to upper side wall surfaces of the first support plates 142a, 142b, and a pair of third support plates 142d, 142e extending substantially parallel to each other along and joined to a vertical surface of the second support plate 142c.

The third support plates 142d, 142e have respective ridges 148 disposed on surfaces thereof and extending vertically substantially parallel to each other. The ridges 148 slidably engage in respective slots 150 defined respectively in the fourth workpiece support members 134a, 134b, so that the fourth workpiece support members 134a, 134b can smoothly be guided for vertical movement by the ridges 148.

When the pressing surfaces 136 of the respective fourth workpiece support members 134a, 134b engage the respective slanted surfaces 138 of the third workpiece support members 130a, 130b and push the third workpiece support members 130a, 130b, the third workpiece support members 130a, 130b generate reactive forces. The reactive forces thus generated are borne by the third support plates 142d, 142e held by the vertically extending first support plates 142a, 142b.

The second bracket 68 which projects outwardly from the base 60 has a first side wall 68a with a fourth air cylinder 152 fixedly mounted thereon. The fourth air cylinder 152 has a first piston rod 152a whose distal end is connected to the connecting plate 124 for displacing the movable stage 64 in its entirety along the axial directions of the connecting rod 30.

The fourth air cylinder 152 is of the double rod type including the first piston rod 152a and a second piston rod 152b which project respectively from the opposite ends thereof along the axis of a cylinder tube thereof. The first piston rod 152a is fixed to the connecting plate 124 joined to the slide block 118, and the second piston rod 152b has its distal end as a free end.

The first side wall 68a of the second bracket 68 supports thereon a pair of backup cylinders 153, 155 fixed thereto with the fourth air cylinder 152 disposed therebetween. The backup cylinders 153, 155 have respective piston rods whose distal ends are coupled to the connecting plate 124 for displacing the movable stage 64 in its entirety along the axial directions of the connecting rod 30 to bring the fractured surface of the cap part 32 which is displaced in unison with the movable stage 64 into abutment against the fractured surface of the rod part 34 which is fixed in position, as described later.

The second bracket 68 also has a second side wall 68b with a fifth air cylinder 154 fixed thereto. The fifth air cylinder 154 has a piston rod 154a whose distal end is positioned in facing relationship to and engageable with the second piston rod 152b of the fourth air cylinder 152. When the fifth air cylinder 154 is actuated to extend the piston rod 154a, the piston rod 154a engages and presses the second piston rod 152b of the fourth air cylinder 152 to displace the movable stage 64 in its entirety horizontally.

The cracking mechanism 54 comprises the first and second mandrels 114, 120 having the respective semicircular protrusions 114a, 120a to be placed in the joint hole 36 in the larger end 38, and the wedge 122 to be pressed in for spreading the first and second mandrels 114, 120 apart from each other.

The semicircular protrusions 114a, 120a have the recesses 114b, 120b into which the wedge 122 are inserted. The recess 114b in the first mandrel 114 on the fixed stage 62 is defined by a substantially vertical wall surface, and the recess 120b in the second mandrel 120 on the movable stage 64 is defined by a tapered surface slanted outwardly in the upward direction (see FIGS. 4 and 6).

The wedge 122 has a tapered surface 122a which is progressively slanted away from a vertical plane toward the upper distal end thereof. The wedge 122 is inserted into the recesses 114b, 120b such that the tapered surface 122a is held in sliding contact with the wall surface of the second mandrel 120. When the wedge 122 is urged to move downwardly in FIG. 4, the tapered surface 122a slides against the wall surface of the second mandrel 120, and the first mandrel 114 and the second mandrel 120 are slidingly spread away from each other.

As shown in FIG. 7, the preload applying mechanism 56 has a third oil cylinder 156 for generating a preload to be applied to the wedge 122. The third oil cylinder 156 has a piston rod (a load transmitter) 162 coupled to the lower end of the wedge 122 through a joint mechanism 160 including a joint pin 158, etc., and a piston 164 having a step 164a engaging an annular step 162a on the piston rod 162.

The piston rod 162 extends centrally through the piston 164 and is slidable with respect to the piston 164. The piston 164 is displaceable in unison with the piston rod 162 in the direction to press in the wedge 122, and is movable separately from the piston rod 162 in a direction opposite to the direction to press in the wedge 122. Stated otherwise, the third oil cylinder 156 applies the preload only in one direction (downward direction) of the piston rod 162 through the piston 164.

The preload applying mechanism 56 and the loading mechanism 58 have a common load transmitting shaft (a load transmitter) 166 connected to the wedge 122 through the piston rod 162. The shaft 166 is integral with the piston rod 162 through the step 162a, and has a flange 166a at an end thereof remote from the piston rod 162. The flange 166a is positionally adjustable in the axial directions of the shaft 166.

The loading mechanism 58 has a vertically movable table 168 supporting the weights 57 thereon and movable downwardly into hitting engagement with the flange 166a to generate an impact load to be applied to the wedge 122 via the shaft 166, a pair of guide members 170a, 170b on which the vertically movable table 168 is vertically slidably guided, and a pair of dampers 172a, 172b for absorbing shocks imposed on the vertically movable table 168 when it falls.

The loading mechanism 58 also has a stopper mechanism (not shown) for adjusting the lower end portion of a downward stroke of the vertically movable table 168, a vertically movable table returning mechanism (not shown) for returning the vertically movable table 168 which has fallen back to an upper standby position, and a returning cylinder (not shown) for returning the wedge 122 which has been displaced downwardly to crack the larger end 38 of the connecting rod 30 back to an initial position.

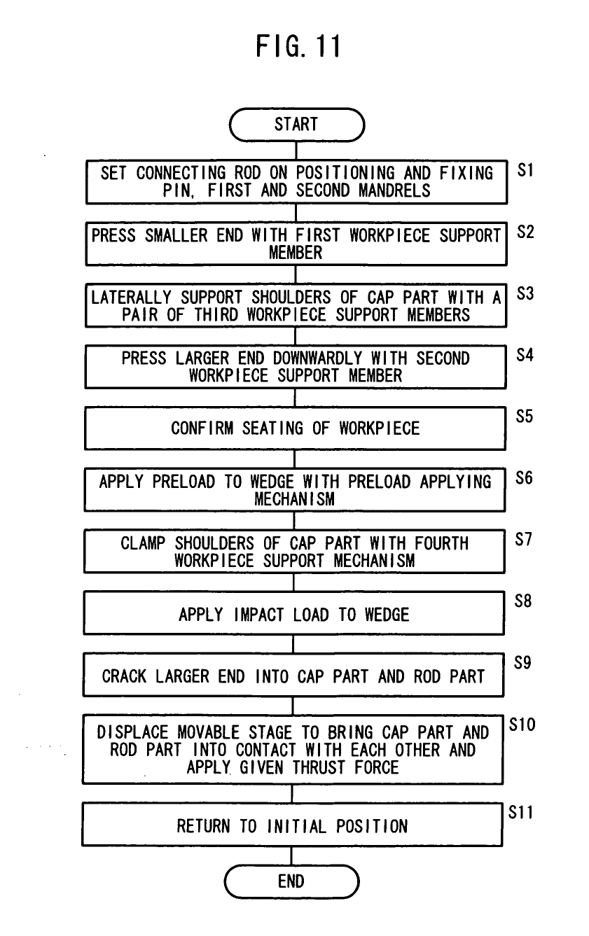

The cracking apparatus 50 according to the embodiment of the present invention is basically constructed as described above. Operation and advantages of the cracking apparatus 50 will be described in detail below with reference to a flowchart shown in FIG. 11.

First, the integrally formed connecting rod 30 is set in the workpiece positioning and holding mechanism 52 (see FIG. 4). At this time, the smaller end 40 is positioned by the positioning and fixing pin 110, and the joint hole 36 in the larger end 38 is fitted over the combined semicircular protrusions 114a, 120a of the first and second mandrels 114, 120 (step S1).

The connecting rod 30 thus set in position is then held in position by the workpiece positioning and holding mechanism 52. Specifically, the first oil cylinder 72 is actuated to displace the movable block 76 coupled to the distal end of the piston rod 72a toward the connecting rod 30 while the movable block 76 is being guided by the guide rail 74. The first workpiece support member 78 fixed in the groove in the movable block 76 engages the smaller end 40 of the connecting rod 30 and presses the smaller end 40 axially toward the larger end 38 (step S2).

As shown in FIG. 5, the first workpiece support member 78 moves horizontally into the recess 106 of substantially rectangular cross section defined centrally in the bifurcated fixed block 108. The engaging slot 80 of V-shaped cross section defined in the distal end of the first workpiece support member 78 engages the smaller end 40 of the connecting rod 30 coaxially along the axial direction of the connecting rod 30.

Then, the third air cylinders 126a, 126b are actuated to displace the third workpiece support members 130a, 130b, which are coupled to the piston rods of the third air cylinders 126a, 126b by the shafts 128, slidably axially toward the connecting rod 30 while the third workpiece support members 130a, 130b are being guided by the second guide elements 140a through 140d. The teeth 132 on the axial ends of the respective third workpiece support members 130a, 130b engage the respective shoulders of the cap part 32 of the connecting rod 30, and press the connecting rod 30 axially in the direction from the larger end 38 toward the smaller end 40, so that the shoulders of the cap part 32 are supported laterally (horizontally) (step S3).

At this time, the teeth 132 on the axial ends of the respective third workpiece support members 130a, 130b lightly press the respective shoulders of the cap part 32 of the connecting rod 30 to bring the tilt (axis) of the connecting rod 30 into alignment with a preset positioning direction, i.e., to correct the axial direction of the connecting rod 30.

Then, the second air cylinder 94 is actuated to extend the piston rod 94a coupled to the joint member 96, turning the second workpiece support member 104 downwardly a given angle about the third pin 100. When the second workpiece support member 104 is turned the given angle, the substantially Y-shaped presser 104a on its distal end contacts the upper surface of the larger end 38 at two points near the joint hole 36, and presses the larger end 38 downwardly (step S4).

At this time, the semicircular protrusions 114a, 120a of the first and second mandrels 114, 120 engage in the joint hole 36 in the larger end 38, and the positioning and fixing pin 110 engages in the hole in the smaller end 40. A seating confirming mechanism (not shown) confirms when the connecting rod 30 is seated on an upper flat surface of the first mandrel 114 (step 5).

Specifically, for example, the seating confirming mechanism comprises an air outlet hole defined in the upper flat surface of the first mandrel 114, and air from an air source is discharged from the air outlet hole. When the connecting rod 30 is seated on the upper flat surface of the first mandrel 114, the air outlet hole is closed, and a sensor (not shown) detects a reduction in the rate of air discharged from the air outlet hole, i.e., detects a reduction in the pressure of air discharged from the air outlet hole. Therefore, the seating of the connecting rod 30 on the upper flat surface of the first mandrel 114 can reliably be confirmed based on a signal from the sensor.

Then, the third oil cylinder 156 of the preload applying mechanism 56 is actuated to displace the piston 164 downwardly. The downward displacement of the piston 164 causes the step 162a engaging the step 164a to move the piston rod 162 downwardly (see FIG. 7). At the same time, the piston rod 162 displaces the wedge 122 coupled thereto downwardly, thereby applying a preload to the wedge 122 (step S6).

The wedge 122 which is sandwiched by the semicircular protrusions 114a, 120a is pressed into the recesses 114b, 120b. When the wedge 122 is pressed downwardly, the tapered surface of the second mandrel 120 which defines the recess 120b and the tapered surface 122a of the wedge 122 slide against each other, slightly spreading the first and second mandrels 114, 120 apart from each other. The semicircular protrusion 114a of the first mandrel 114 and the semicircular protrusion 120a of the second mandrel 120 are horizontally spaced a given distance from each other, and pressed against the respective inner surfaces of the joint hole 36 in the larger end.

The preload that is applied to the wedge 122 at this time is set to such a level that the larger end 38 is not fractured even when the semicircular protrusions 114a, 120a are pressed against the respective inner surfaces of the joint hole 36, i.e., a level which allows the larger end 38 to be elastically deformable. Accordingly, the larger end 38 and the semicircular protrusions 114a, 120a of the first and second mandrels 114, 120 are prevented from wobbling with respect to each other, and the connecting rod 30 as a workpiece is securely held in position by the semicircular protrusions 114a, 120a of the first and second mandrels 114, 120.

With the preload being applied to the joint hole 36 in the larger end 38, the second oil cylinders 146a, 146b are actuated to displace the fourth workpiece support members 134a, 134b, each in the form of a block, vertically downwardly. At this time, the ridges 148 on the third support plates 142d, 142e of the support assembly 142 engage in the respective slots 150 defined respectively in the fourth workpiece support members 134a, 134b which confront the third support plates 142d, 142e, guiding the fourth workpiece support members 134a, 134b to move smoothly in the downward direction (see FIG. 3).

When the fourth workpiece support members 134a, 134b are lowered, the pressing surfaces 136 of the respective fourth workpiece support members 134a, 134b slidingly engage the respective slanted surfaces 138 on the ends of the third workpiece support members 130a, 130b, pushing the third workpiece support members 130a, 130b toward the cap part 32 of the connecting rod 30 (step S7).

As a result, the cap part 32 of the connecting rod 30 is completely locked in position between the third workpiece support members 130a, 130b which are pressed by the fourth workpiece support members 134a, 134b as they are lowered and support the respective shoulders of the cap part 32, and the semicircular protrusion 120a of the second mandrel 120 between the shoulders of the cap part 32.

With the cap part 32 of the connecting rod 30 being locked firmly in position, the vertically movable table 168 is released, and thereafter the vertically movable table 168 and the weights 57 drop while being guided by the guide members 170a, 170b. When the vertically movable table 168 impinges on the flange 166a on the shaft 166, the shaft 166 is urged to move downwardly, applying an impact load to the wedge 122 (see FIG. 8) (step S8). At this time, since the piston 164 of the third oil cylinder 156 is movable with respect to the shaft 166 in the direction opposite to the direction in which the wedge 122 is pressed in, i.e., the direction in which the impact load is applied, the impact load is not attenuated by the third oil cylinder 156, but is reliably imparted to the wedge 122.

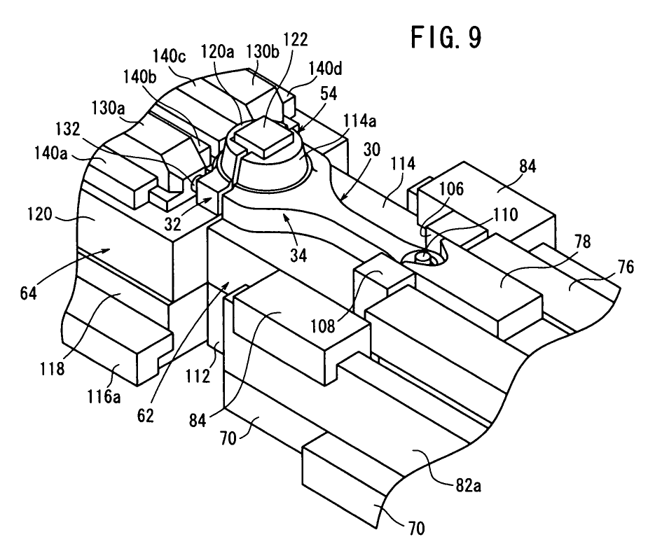

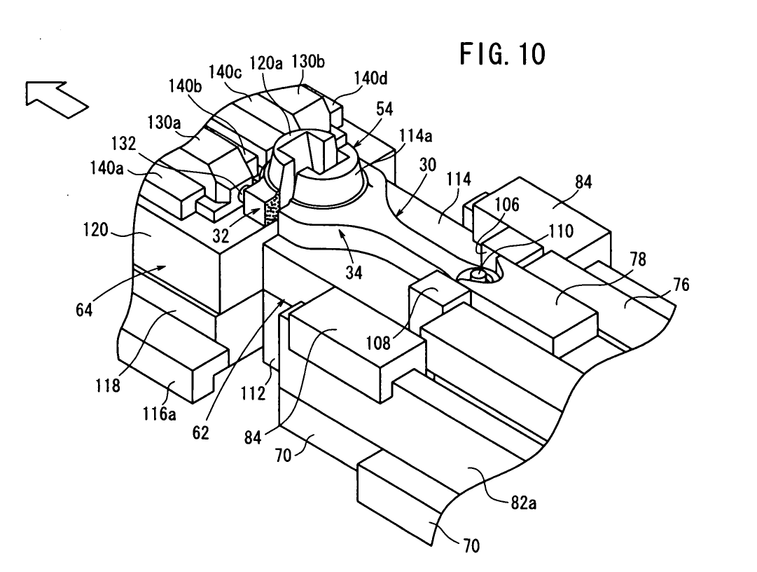

Under the applied impact load, the wedge 122 is further pressed into the recesses 114b, 120b of the first and second mandrels 114, 120. The tapered surface of the second mandrel 120 which defines the recess 120b and the tapered surface 122a of the wedge 122 slide against each other, while further spreading the first and second mandrels 114, 120 apart from each other. When the first and second mandrels 114, 120 are thus spaced away from each other substantially horizontally, the larger end 38 is deformed beyond its resiliently deformable range and cracked at the cracking regions 44 where stresses are concentrated into the cap part 32 and the rod part 34 (see FIGS. 9 and 10) (step S9). Since the cap part 32 is held by the teeth 132 on the third workpiece support members 130a, 130b under the pressure from the second oil cylinders 146a, 146b, the fractured cap part 32 is prevented from being scattered around.

Specifically, with the first mandrel 114 on the fixed stage 62 being fixed in position, when the impact load is applied to the wedge 122, the second mandrel 120 on the movable stage 64 is slidingly displaced in unison with the slide block 118 on the base 60 while being guided by the first guide elements 116a, 116b.

In other words, the rod part 34 of the connecting rod 30 is fixedly mounted on the fixed stage 62 by the first mandrel 114, the positioning and fixing pin 110, and the first workpiece support member 78, and the cap part 32 is firmly locked in position by the fourth workpiece support members 134a, 134b, the third workpiece support members 130a, 130b, and the second mandrel 120. When the second mandrel 120 and the slide block 118 of the movable stage 64 are then slidingly displaced on the base 60 away from the fixed stage 62, the larger end 38 of the connecting rod 30 is cracked into the cap part 32 and the rod part 34.

After the larger end 38 of the connecting rod 30 is cracked into the cap part 32 and the rod part 34, the non-illustrated returning cylinder is actuated to lift the wedge 122 back to its initial position.

When the upper end of the wedge 122 projects upwardly a predetermined distance from the upper surfaces of the cap part 32 and the rod part 34, the fourth air cylinder 152 and the backup cylinders 153, 155, whose respective piston rods 152a, 153a, 155a have their distal ends fixed to the movable stage 64 by the second blanket 68, are actuated substantially at the same time to extend the piston rods 152a, 153a, 155a to displace the movable stage 64 toward the fixed stage 62, thereby bringing the fractured surface of the cap part 32 and the fractured surface of the rod part 34 into abutting engagement with each other.

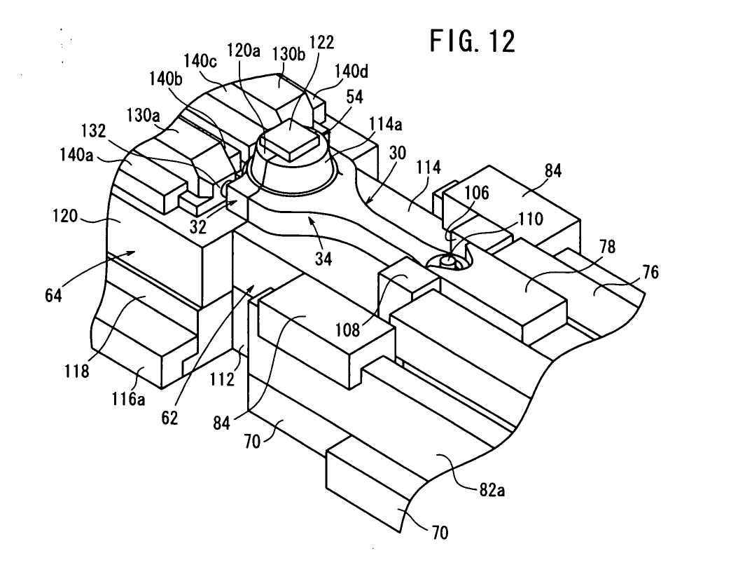

With the cap part 32 and the rod part 34 being in abutment against each other, the non-illustrated switching valve is operated to change the pressure of oil supplied to the first oil cylinder 72 from a low level to a high level to increase the force (thrust force) with which to press the smaller end 40 of the connecting rod 30 axially toward the larger end 38 thereof. At the same time, the non-illustrated switching valve is operated to change the pressure of oil supplied to the second oil cylinders 146a, 146b from a low level to a high level to increase the force (thrust force) with which to press the third workpiece support members 130a, 130b toward the cap part 32 of the connecting rod 30. As a result, as shown in FIG. 12, the fractured surface of the cap part 32 and the fractured surface of the rod part 34 are placed in abutting engagement with each other under the desired thrust force (step S10). Stated otherwise, after the fractured surface of the cap part 32 and the fractured surface of the rod part 34 are brought into abutting engagement with each other, the thrust forces (pressing forces) applied to the mating fractured surfaces are simultaneously changed from the low level to the high level to promote removal or release of fragments which may be produced in the mating fractured surfaces.

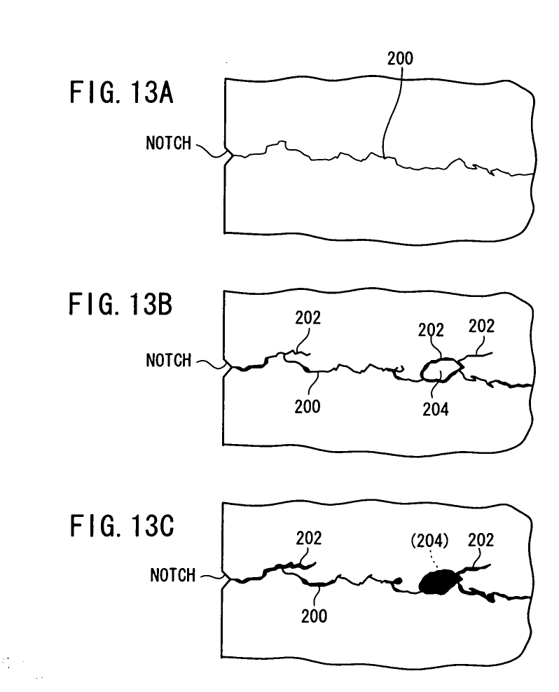

As shown in FIGS. 13A through 13C, when the larger end 38 is fractured into the cap part 32 and the rod part 34, a main crack 200 is propagated to cause a brittle fracture. During the propagation of the main crack 200, the main crack 200 tends to branch into small auxiliary cracks 202. When the connecting rod 30 is assembled in an internal combustion engine or when the internal combustion engine incorporating the connecting rod 30 is operated, the auxiliary cracks 202 grow or are propagated together, giving rise to a region 204 where there is almost no contact between the fractured surface of the cap part 32 and the fractured surface of the rod part 34. The region 204 is so brittle that when a load (stress) is applied to the region 204, the region 204 comes off as a fragment, as shown in FIG. 13C.

According to the present embodiment, immediately after the connecting rod 30 is cracked into the cap part 32 and the rod part 34 by the dropping wedge 122, the fourth air cylinder 152 and the backup cylinders 153, 155 are actuated substantially simultaneously to displace the movable stage 64 toward the fixed stage 62. After the fractured surface of the cap part 32 and the fractured surface of the rod part 34 have been brought into abutment against each other, the desired thrust forces are applied to the mating fractured surfaces to release fragments produced in the mating fractured surfaces or promote the release of fragments produced in the mating fractured surfaces.

As described above, immediately after the connecting rod 30 is cracked into the cap part 32 and the rod part 34, the cap part 32 and the rod part 34 are held respectively by the movable stage 64 and the fixed stage 62. Then, the movable stage 64 is displaced toward the fixed stage 62 to bring the fractured surface of the cap part 32 into abutment against the fractured surface of the rod part 34. The mating fractured surfaces are further pressed together to remove fragments produced in the mating fractured surfaces or promote the release of fragments produced in the mating fractured surfaces.

After the release of fragments has been promoted in the connecting rod 30, the fragments can reliably be removed from the fractured surfaces by a metal brush, an adhesive tape, a suction machine, or a vibrator in a next process. Specifically, if a metal brush is used, then the fractured surfaces are brushed by the metal brush to remove fragments from the fractured surfaces. If an adhesive tape is used, then the adhesive tape is applied to the fractured surfaces and then peeled off from the fractured surfaces to remove fragments from the fractured surfaces. If a suction machine is used, then a negative pressure is applied by the suction machine to the fractured surfaces to remove fragments from the fractured surfaces. In either case, the fragments can reliably be removed from the fractured surfaces.

After fragments have been removed from the fractured surface of the cap part 32 and the fractured surface of the rod part 34, or after the release of fragments from the fractured surface of the cap part 32 and the fractured surface of the rod part 34 has been promoted, the first oil cylinder 72 and the second oil cylinders 146a, 146b which have applied the thrust forces to the cap part 32 and the rod part 34 are inactivated to release the mating fractured surfaces of the connecting rod 30 of the thrust forces. As a result, the mating fractured surfaces of the cap part 32 and the rod part 34 are slightly spaced from each other, allowing fragments produced in the mating fractured surfaces to be smoothly released.

Then, the first oil cylinder 72, the second oil cylinders 146a, 146b, the second air cylinder 94, the third air cylinders 126a, 126b, the fourth air cylinder 152, and the backup cylinders 153, 155 are actuated to return the first through fourth workpiece support members 78, 104, 130a, 130b, 134a, 134b substantially simultaneously to their initial positions (step S11).

After the components which have restrained the cap part 32 and the rod part 34 of the fractured connecting rod 30 have been returned to their initial positions, thereby releasing the connecting rod 30, the cap part 32 and the rod part 34 are gripped by respective chuck mechanisms mounted on arms of a multi-axis robot (not shown), and transferred thereby to a next process. Finally, the fifth air cylinder 154 is actuated to displace the movable stage 64 back to its initial position.

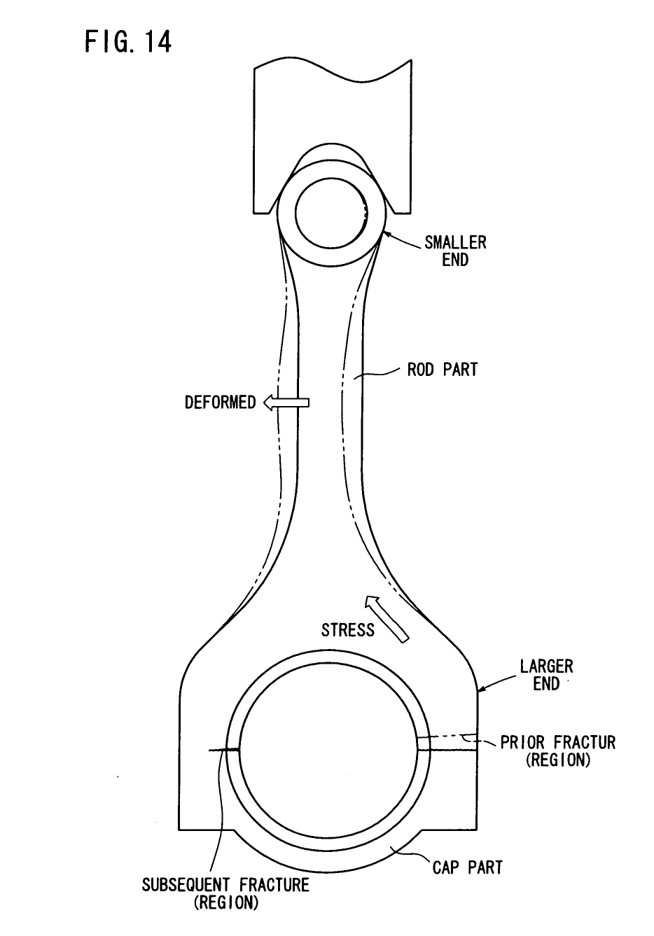

For example, as shown in FIG. 14, when a larger end is cracked into a cap part and a rod part by a conventional cracking apparatus (not shown), if there is a time lag between a prior fracture (region) and a subsequent fracture (region), then stresses from the prior fracture act on the rod part, applying a force tending to deform the rod part toward the subsequent fracture region. As a result, the rod part is deformed as indicated by the two-dot-and-dash lines in FIG. 14, and the hole in the smaller end is deformed. The connecting rod 30 is required to have high dimensional accuracy with respect to the configuration of the rod part and the configuration of the hole in the smaller end because of desired product characteristics thereof.

Stated otherwise, when the integrally formed connecting rod 30 is cracked into two parts, i.e., the cap part 32 and the rod part 34, bending stresses act on a portion of the cracked parts, the cracked surfaces tend to be distorted partly or the accuracy of the parts tends to be adversely affected. Specifically, each of the two parts has two legs after it has been cracked. When the parts are cracked, their cracking does not progress simultaneously in the legs. Instead, one of the legs starts to be cracked earlier, and then other leg starts to be cracked with a slight time lag. When the cracking of one of the legs which is fractured earlier is finished, the cracking of the other leg which is fractured subsequently is still in progress. In a final phase of the cracking of the other leg, the parts begin to be separated from each other in the leg which has been cracked earlier.

According to the present embodiment, the rod part 34 of the larger end 38 is fixed to the fixed stage 62, and the cap part 32 is firmly fixed to the movable stage 64 by the third workpiece support members 130a, 130b and the second oil cylinders 146a, 146b which lock the third workpiece support members 130a, 130b.

When the larger end 38 is cracked into the cap part 32 and the rod part 34, only the cap part 32 is displaced in unison with the movable stage 64. Therefore, any time lag between the prior fracture and the subsequent fracture at the fractured surfaces of the cap part 32 and the rod part 34 is minimized.

According to the present embodiment, therefore, there is no need to establish timing to release the external pressure, and any time lag between the prior fracture and the subsequent fracture is minimized.

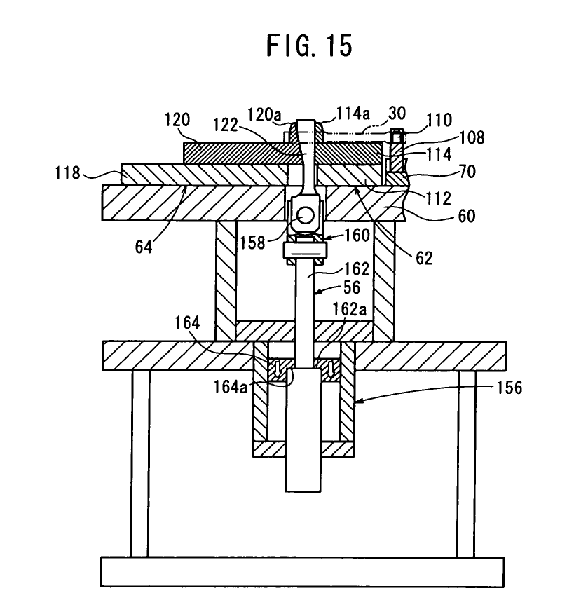

According to the present embodiment, furthermore, the connecting rod 30 is cracked by the impact load that is generated when the weights drop. FIG. 15 shows a cracking apparatus according to another embodiment of the present invention in which the oil cylinder 156 functioning as a single actuator pulls the wedge 122 downwardly, thereby applying an impact load to the wedge 122.

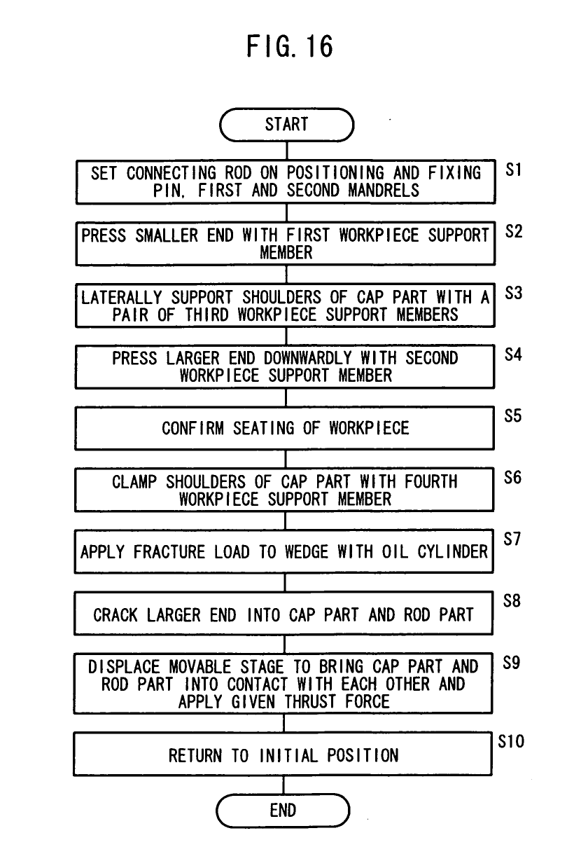

FIG. 16 shows an operation sequence of the cracking apparatus shown in FIG. 15. In the operation sequence shown in FIG. 16, no preload is applied to the wedge 122, and the pulling force applied by the oil cylinder 156 is gradually increased to crack the larger end 38 into the cap part 32 and the rod part 34 (see step S7).

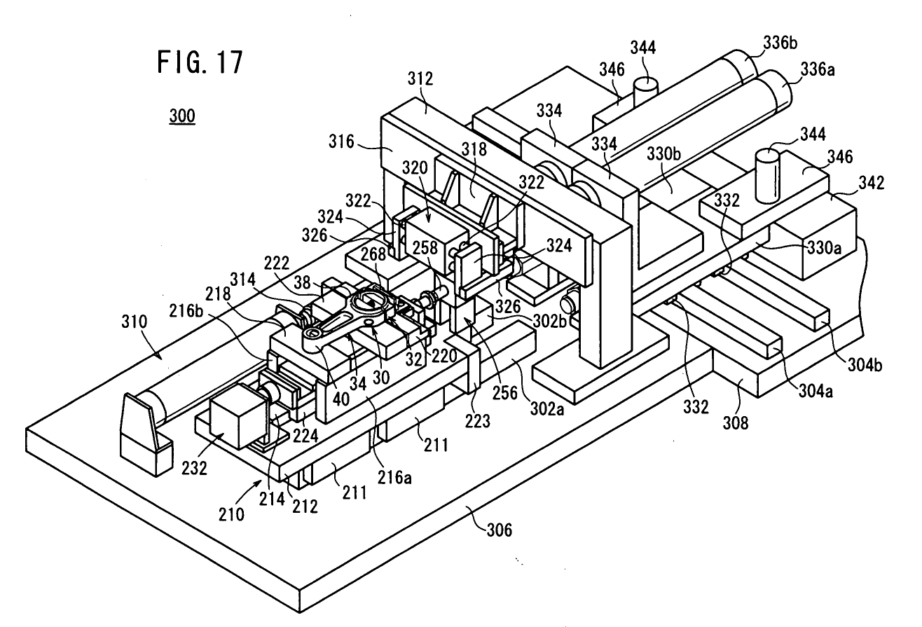

FIG. 17 shows a joining apparatus 300 for carrying out the method of manufacturing a connecting rod according to the present invention. The joining apparatus 300 incorporates a positioning device 210 for positioning the cap part 32 and the rod part 34 to complementarily align the irregularities of the fractured surfaces thereof with each other.

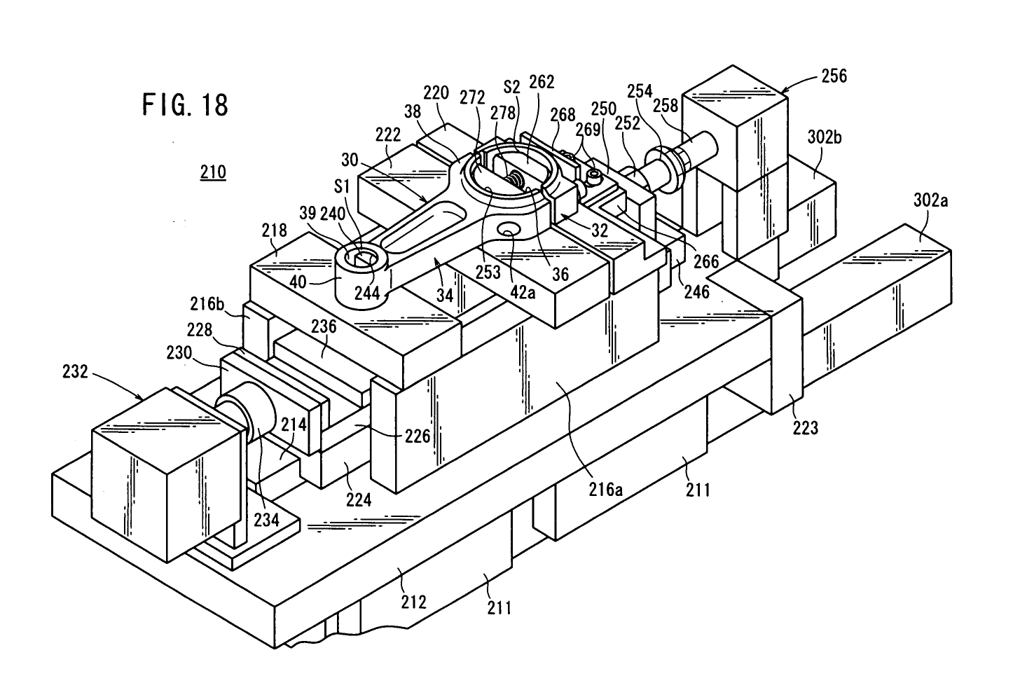

The positioning device 210 will first be described below with reference to FIGS. 18, 19, and 20.

The positioning device 210 has a base 212 with slide plates 211 having elongate grooves (not shown) and mounted on a lower surface thereof, a guide rail 214 laid on the base 212, two side plates 216a, 216b mounted substantially parallel to each other on the base 212 in longitudinally surrounding relation to the guide rail 214, first and second seats 218, 220 positioned on and fixed to upper surfaces at longitudinal ends of the side plates 216a, 216b, and a third seat 222 fixedly mounted on the upper surfaces of the side plates 216a, 216b at a position near the second seat 220 between the first and second seats 218, 220.

A rod joint plate 223 which is joined to a piston rod 314 of a displacement cylinder 310 is fitted in recesses defined in an end of the base 212.

The guide rail 214 (see FIG. 18), which is in the form of a wide thick plate, supports on an end portion thereof a first engaging member 224 having a recess defined in a lower surface thereof and fitted over the guide rail 214. A flat plate 226 is placed on an upper end of the first engaging member 224, and a joint plate 228 is vertically mounted on an end of the flat plate 226. A presser plate 230 is fixed to end faces of the flat plate 226 and the joint plate 228. A first cylinder 232 serving as a first displacing mechanism has a piston rod 234 of the first cylinder 232 coupled to the presser plate 230.

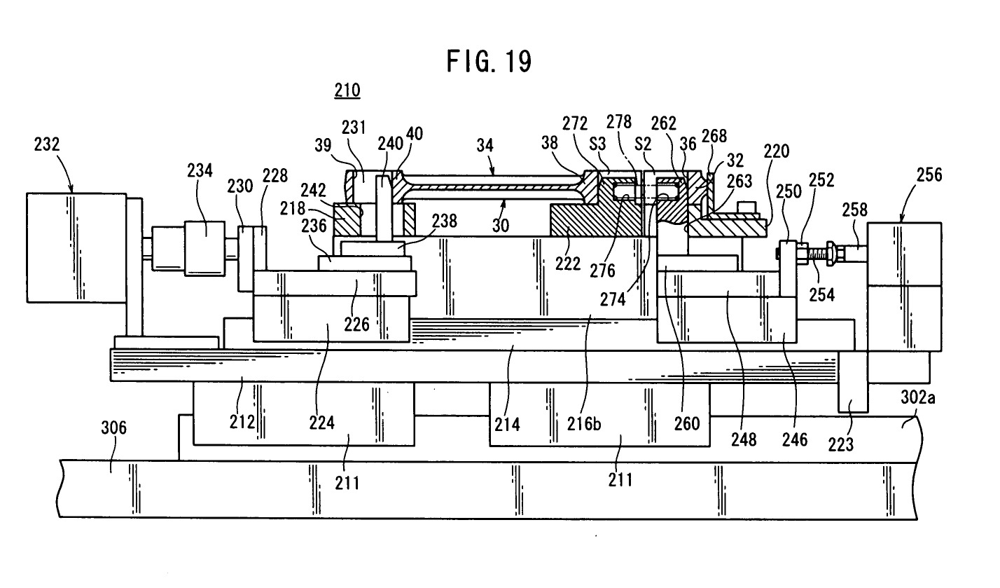

A first positioning member 240 (see FIG. 19) is vertically mounted on the other end of the flat plate 226 with spacers 236, 238 interposed therebetween. The first positioning member 240 extends upwardly through a through hole 242 defined in the first seat 218 into the small hole 39 defined in the smaller end of the connecting rod 30. When the piston rod 234 of the first cylinder 232 is moved back and forth, the first engaging member 224 is displaced on the guide rail 214 in unison with the piston rod 234.

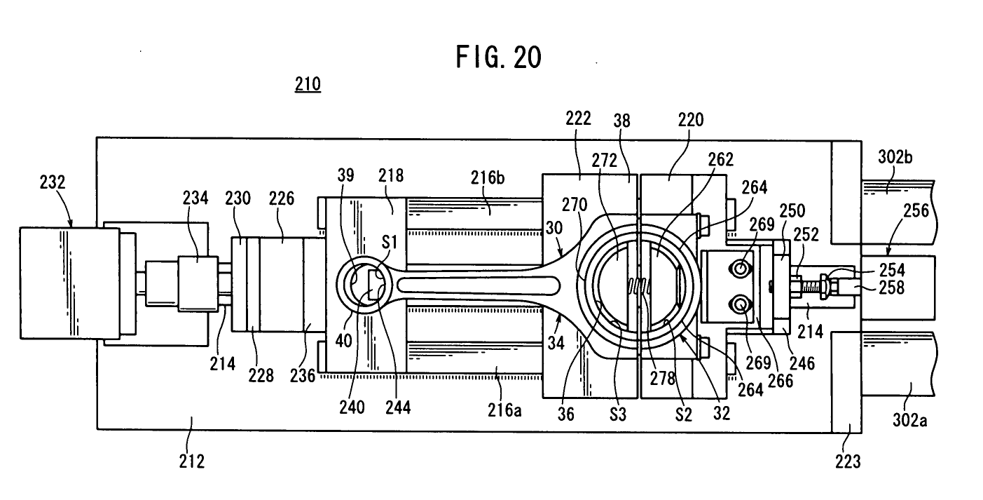

The first positioning member 240 has a curved surface 244 (see FIG. 20) complementary in shape to a first inner circumferential wall surface S1 of the connecting rod 30 which defines the small hole 39. The curved surface 244 is held in contact with the portion of the first inner circumferential wall surface S1 which is closer to the cap part 32.

Similarly, the guide rail 214 (see FIG. 18) supports on an opposite end portion thereof a second engaging member 246 having a recess defined in a lower surface thereof and fitted over the guide rail 214 (see FIG. 19). A spacer 248 and a vertical displacement plate 250 which is longer than the spacer 248 are mounted on an upper surface of the second engaging member 246. A screw 254 positioned by a nut 252 is threaded through the displacement plate 250. The screw 254 has a head held against a piston rod 258 of a second cylinder 256 serving as a second displacing mechanism.

A second positioning member 262 is vertically disposed on the spacer 248 with another spacer 260 interposed therebetween. The second positioning member 262 extends through a through hole 263 defined in the second seat 220 into the joint hole 36 of the connecting rod 30. The second positioning member 262 has a curved surface 264 (see FIG. 20) complementary in shape to a second inner circumferential wall surface S2 of the cap part 32 which defines the joint hole 36.

As shown in FIG. 18, the second seat 220 has an arm 266 to which an L-shaped frame 268 having a substantially L-shaped cross section is fastened by bolts 269. The L-shaped frame 268 functioning as a holder for holding the cap part 32 is held against an outer wall surface of the cap part 32.

The third seat 222 has a third positioning member 272 projecting from an end thereof which is close to the second seat 220. The third positioning member 272 has a curved surface 270 complementary in shape to a third inner circumferential wall surface S3 of the rod part 34 which defines the joint hole 36. The rod part 34 is positioned and fixed in position by the third positioning member 272.

The second positioning member 262 and the third positioning member 272 have respective cavities 274, 276 defined in mutually facing positions thereof (see FIG. 19). A helical spring 278 as a resilient member is inserted in the cavities 274, 276. Since the second positioning member 262 is displaceable with the second engaging member 246 and the third positioning member 272 is positioned and secured in place together with the third seat 222, the helical spring 278 normally urges the second positioning member 262 to move away from the third positioning member 272.

The joining apparatus 300 (see FIG. 17) also has, in addition to the positioning device 210 constructed as described above, first and second boards 306, 308 having respective pairs of guide rails 302a, 302b and guide rails 304a, 304b mounted on their respective upper surfaces, the first and second boards 306, 308 being disposed adjacent to each other. The positioning device 210 is displaceably placed on the guide rails 302a, 302b on the first board 306 for being guided thereon by the slide plates 211 mounted on the lower surface of the base 212. Specifically, the guide rails 302a, 302b are slidably inserted in the respective elongate grooves in the slide plates 211.

The displacement cylinder 310 is mounted on an upper surface of the first board 306 with a gate-like mount 312 vertically disposed thereon. The displacement cylinder 310 has a piston rod 314 whose distal end is coupled to the rod joint plate 223 fitted in the end of the base 212 on which the second cylinder 256 is mounted.

A transverse position limiting cylinder 320 is mounted by a spacer plate 316 and a bracket 318 on an end face of the gate-like mount 312 which faces a horizontal portion extending in the longitudinal direction of the first board 306 and supporting the positioning device 210 thereon.

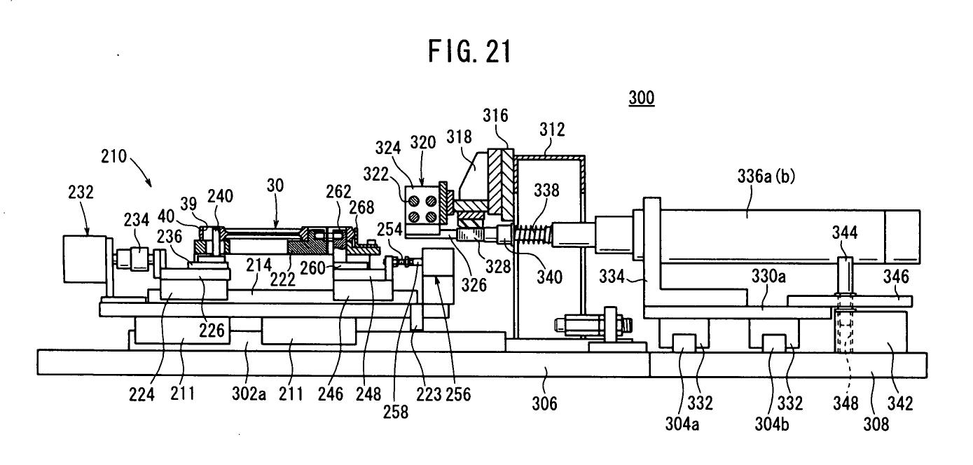

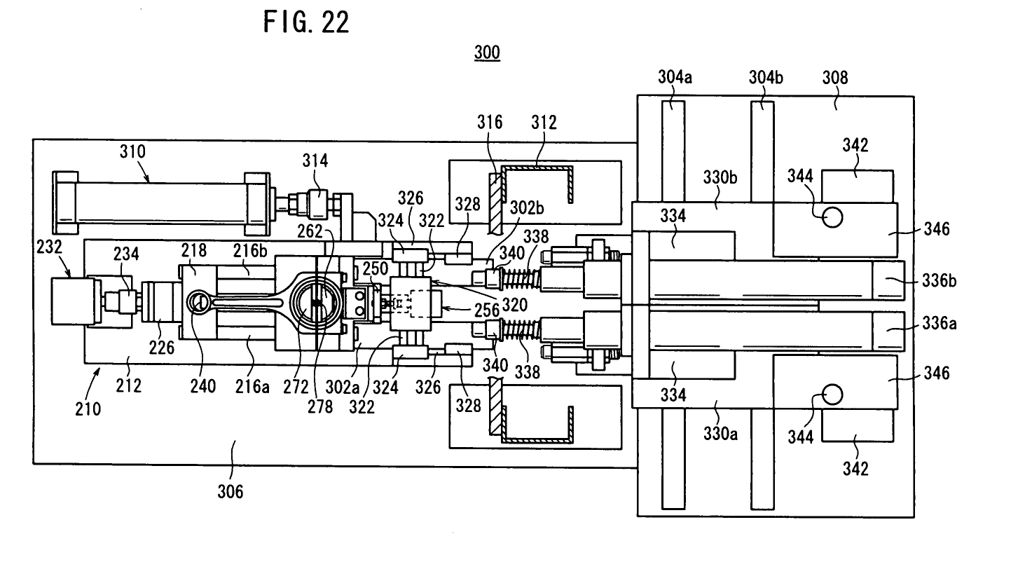

The transverse position limiting cylinder 320 has rods 322 axially movably projecting from opposite sides thereof and connected to a pair of laterally spaced support plates 324. Arms 326 extending toward the gate-like mount 312 are mounted on outer side surfaces of the support plates 324. Dampers 328 are joined to mutually confronting surfaces of the distal ends of the arms 326 (see FIGS. 21, 22).

A pair of mounts 330a, 330b is displaceably mounted on the guide rails 304a, 304b on the second board 308 (see FIG. 17). Grippers 332 are mounted on lower surfaces of the mounts 330a, 330b, and the guide rails 304a, 304b are inserted in respective grooves defined in the lower surfaces of the grippers 332.

L-shaped stays 334 are mounted respectively on the mounts 330a, 330b and support respective nut runners 336a, 336b thereon.

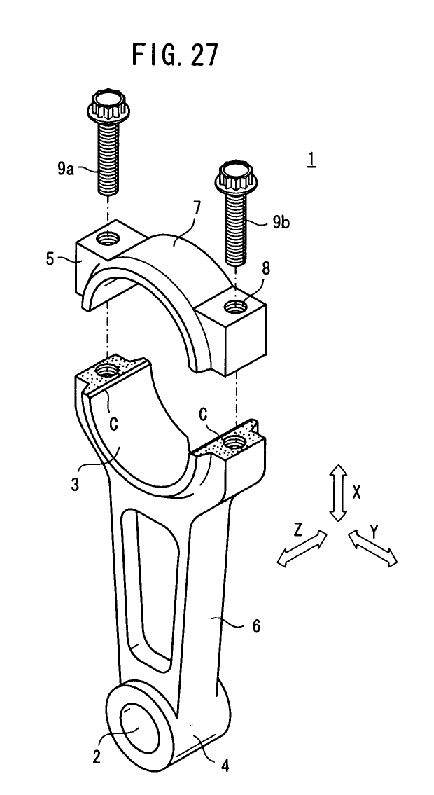

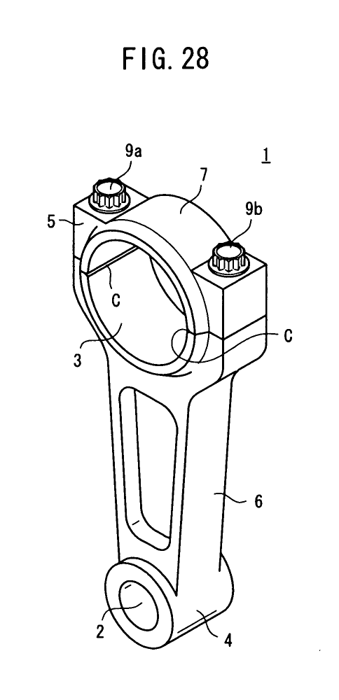

As shown in FIGS. 21, 22, the nut runners 336a, 336b have respective rotatable main shafts 338 and respective sockets 340 mounted respectively on the distal ends of the main shafts 338. The bolts 9a, 9b (see FIG. 27) for fastening the cap part 32 to the rod part 34 have respective heads placed in respective cavities (not shown) defined in the sockets 340. The bolts 9a, 9b are tightened when the main shafts 338 and the sockets 340 are rotated about their own axes.

A substantially channel-shaped pin insertion plate 342 (see FIG. 17) is mounted on the upper end of the second board 308. Presser stop plates 346 are connected to the pin insertion plate 342 by respective pins 344. The pins 344 are inserted in respective pin insertion holes 348 defined in the pin insertion plate 342 (see FIG. 21).

The joining apparatus 300 for carrying out the method of manufacturing a connecting rod according to the present invention is constructed as described above. Operation and advantages of the joining apparatus 300 will be described in detail below.

For positioning the rod part 34 and the cap part 32, the piston rod 234 of the first cylinder 232 is retracted, and the piston rod 258 of the second cylinder 256 is displaced forward. When the piston rod 258 of the second cylinder 256 is displaced forward, the second engaging member 246 coupled to the displacement plate 250 is displaced toward the first cylinder 232 along the guide rail 214.

Upon the displacement of the second engaging member 246, the second positioning member 262 is displaced toward the third positioning member 272, compressing the helical spring 278 that extends between the second positioning member 262 and the third positioning member 272.

The smaller end 40 of the rod part 34 is placed on the first seat 218, and the larger end 38 thereof on the third seat 222. The cap part 32 is placed on the second seat 220.

Then, the first cylinder 232 is actuated. The piston rod 234 is moved forward to cause the presser plate 230, the joint plate 228, and the flat plate 226 to displace the first engaging member 224 along the guide rail 214 toward the second cylinder 256. The first positioning member 240 which is vertically mounted on the flat plate 226 by the two spacers 236, 238 is displaced within the small hole 39 toward the second cylinder 256.

When the first positioning member 240 is displaced, the curved surface 244 of the first positioning member 240 is brought into abutment against the first inner circumferential wall surface S1 which defines the small hole 39. Upon further forward movement of the piston rod 234, the first positioning member 240 is further displaced to push the rod part 34 toward the second cylinder 256.

Since the curved surface 244 of the first positioning member 240 is complementary in shape to the first inner circumferential wall surface S1 which defines the small hole 39, the rod part 34 is prevented from swinging about the small hole 39 when the rod part 34 is moved forward.

The third inner circumferential wall surface S3 of the rod part 34 which defines the joint hole 36 finally abuts against the third positioning member 272 on the third seat 222. Since the third positioning member 272, i.e., the third seat 222, is fixedly mounted on the side plates 216a, 216b, the rod part 34 is held by the third positioning member 272. The rod part 34 is now prevented from moving further forward.

As described above, the curved surface 270 of the third positioning member 272 is complementary in shape to the third inner circumferential wall surface S3 of the rod part 34 which defines the joint hole 36. Therefore, even if the rod part 34 swings about the small hole 39 when the rod part 34 moves forward, the third inner circumferential wall surface S3 is guided by the curved surface 270 of the third positioning member 272, so that the rod part 34 returns to the position from which it has swung.

The rod part 34 that has been cracked from the connecting rod 30 is now positioned in place.

Then, the second cylinder 256 is actuated to retract the piston rod 258. The piston rod 258 is spaced from the head of the screw 254, releasing the second engaging member 246 off the pressing force from the second cylinder 256. The helical spring 278 is resiliently extended under the energy stored therein, displacing the second positioning member 262 away from the third positioning member 272.

The curved surface 264 of the displaced second positioning member 262 presses the second inner circumferential wall surface S2 of the cap part 32 which defines the joint hole 36. The cap part 32 is displaced away from the rod part 34 until finally the cap part 32 is held by the L-shaped frame 268.

Because the curved surface 264 is complementary in shape to the second inner circumferential wall surface S2, the cap part 32 as it is displaced is prevented from swinging about the joint hole 36. The fractured surface of the cap part 32 that is held by the L-shaped frame 268 is thus positioned in alignment with the fractured surface of the rod part 34 in facing relationship thereto. In other words, the rod part 34 and the cap part 32 are positioned highly accurately with respect to each other.

The piston rod 314 of the displacement cylinder 310 is moved forward. As the piston rod 314 is coupled to the rod joint plate 223, the positioning device 210 is displaced along the guide rails 302a, 302b toward the gate-shaped mount 312.

When the piston rod 314 of the displacement cylinder 310 reaches its forward stroke end, the side surfaces of the larger end 38 and the cap part 32 and the dampers 328 on the inner side surfaces of the arms 326 are substantially positionally aligned with each other. Thereafter, the rods 322 of the transverse position limiting cylinder 320 are retracted to cause the arms 326 to positionally limit the side surfaces of the larger end 38 and the cap part 32. As a result, the larger end 38 and the cap part 32 are positioned with higher accuracy.

During the above operation, the mounts 330a, 330b are guided along the guide rails 304a, 304b on the second board 308 and displaced until the sockets 340 of the nut runners 336a, 336b are positionally aligned with the respective bolt holes 42a, 42b of the connecting rod 30.

The mounts 330a, 330b have their respective ends stopped by the presser stop plates 346, causing the nut runners 336a, 336b supported on the L-shaped stays 334 to extend horizontally, but not obliquely.

When the displacement cylinder 310 finishes its operation to move the base 212 and hence the connecting rod 30 forward and also to position the larger end 38 and the cap part with respect to each other, the heads of the bolts 9a, 9b that have been threaded into the bolt holes 42a, 42b by the worker engage respectively in the sockets 340.

With the heads of the bolts 9a, 9b engaging in the sockets 340, the nut runners 336a, 336b are actuated to rotate the main shafts 338 to turn the bolts 9a, 9b with the respective sockets 340.

The externally threaded surfaces of the bolts 9a, 9b engage the internally threaded surfaces of the bolt holes 42a, 42b, fastening the rod part 34 and the cap part 32 to each other without any positional misalignment. Tightening conditions for the bolts 9a, 9b will be described later.

With the above joining apparatus 300, the rod part 34 is positioned by the first positioning member 240 and the third positioning member 272, and the cap part 32 is positioned by the second positioning member 262. Since the first positioning member 240, the second positioning member 262, and the third positioning member 272 have the respective curved surfaces 244, 264, 270 which are complementary in shape to the first inner circumferential wall surface S1 which defines the small hole 39, the second inner circumferential wall surface S2 of the cap part 32 which defines the joint hole 36, and the third inner circumferential wall surface S3 of the rod part 34 which defines the joint hole 36, respectively, the rod part 34 and the cap part 32 are prevented from swinging.

Therefore, the fractured surface of the rod part 34 and the fractured surface of the cap part 32 face each other in linear alignment with each other. Stated otherwise, the rod part 34 and the cap part 32 are positioned highly accurately with respect to each other. Accordingly, the rod part 34 and the cap part 32 can easily be joined into the connecting rod 30, the connecting rod 30 can efficiently be produced with an increased yield.

As a clearance is provided between the first seat 218 and the third seat 222, a tool for applying lubricating oil can be inserted through the clearance to apply the lubricating oil to the guide rail 214 while the positioning device 210 is in use as described above. Therefore, the positioning device 210 can easily be serviced for maintenance. The clearance provided between the first seat 218 and the third seat 222 is also effective to prevent the positioning device 210 from increasing its weight.

In the illustrated joining apparatus 300, the first seat 218 and the third seat 222 are shown as being separate from each other. However, the first seat 218 and the third seat 222 may be of a unitary structure. Specifically, a first seat longer than the first seat 218 may be provided, and the smaller end 40 and the larger end 38 of the rod part 34 may be placed on the longer first seat. The third positioning member may be separate from the first seat and may vertically be mounted on the first seat.

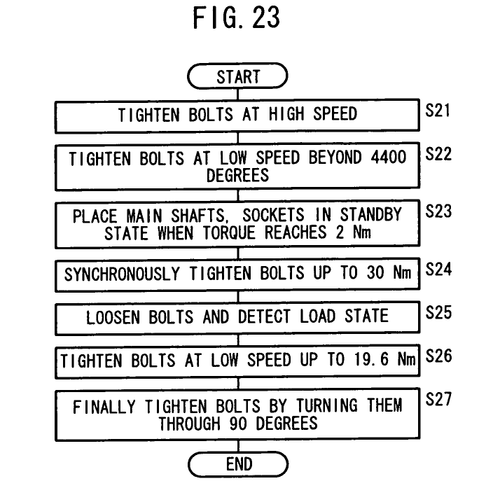

Tightening conditions for tightening the bolts 9a, 9b inserted into the bolt holes 42a, 42b while the fractured surfaces of the cap part 32 and the rod part 34 are being positioned with respect to each other, will be described in detail below with reference to a flowchart shown in FIG. 23.

In the description which follows, the bolts 9a, 9b are tightened according to the angle controlled tightening process. According to the angle controlled tightening process, a snug torque is set to 19.6 Nm and the bolts 9a, 9b are turned through 90 degrees. In the angle controlled tightening process, it is difficult to determine the snug torque highly accurately. Tightening conditions to be described below are established for increasing the tightening accuracy for the bolts 9a, 9b. Based on experimental data produced by measuring, with a torque wrench, the torque of the bolts 9a, 9b that were manually tightened by worker's fingers, a temporary tightening torque is set to 2 Nm.

First, the nut runners 336a, 336b are actuated to turn and tighten the bolts 9a, 9b at a high speed (step S21).

When the bolts 9a, 9b are tightened at a high speed beyond a rotational angle of 4400 degrees according to the angle controlled process, the rotational speed of the main shafts 338 and the sockets 340 of the nut runners 336a, 336b is reduced, and the bolts 9a, 9b are turned at a low speed (step S22). The rotational angle across which the high speed changes to the low speed is not limited to 4400 degrees, but may differ depending on the type and size of the connecting rod 30, and the assembling production line for the connecting rod 30.

The bolts 9a, 9b are tightened by being turned at the low speed, bringing the fractured surface of the cap part 32 and the fractured surface of the rod part 34 toward each other. The fractured surface of the cap part 32 and the fractured surface of the rod part 34 are held in contact with each other when the surface irregularities of the fractured surfaces of the cap part 32 and the rod part 34 are complementarily combined with each other. At this time, a positional misalignment between the fractured surfaces of the cap part 32 and the rod part 34 due to the shrinkage of the cap part 32 at the time the connecting rod 30 is cracked is corrected. Since the positional misalignment between the fractured surfaces of the cap part 32 and the rod part 34 is corrected, the cap part 32 and the rod part 34 are held in coaxial alignment with each other, and a transverse dimensional difference between the cap part 32 and the rod part 34 due to the shrinkage of the cap part 32 is distributed substantially equally in the transverse direction. When the tightening torque of the bolts 9a, 9b which are tightened at the low speed reaches the preset torque of 2 Nm, the nut runners 136a, 136b are inactivated to stop rotating the main shafts 338 and the sockets 340, and keep them in a standby state (step S23).

The preset torque of 2 Nm is established as the temporary tightening torque. According to the present embodiment, times to tighten the bolts 9a, 9b with the respective nut runners 336a, 336b are not equalized, but the temporary tightening torque is set based on experimental data produced by measuring, with a torque wrench, the maximum torque of the bolts 9a, 9b that were manually tightened by worker's fingers. Tightening processes for the respective bolts 9a, 9b are equalized from the time (origin) when the tightening torque of the bolts 9a, 9b reaches the temporary tightening torque of 2 Nm.

Then, the nut runners 336a, 336b are actuated again to tighten the bolts 9a, 9b in synchronism with each other until the tightening torque of the bolts 9a, 9b reaches a predetermined torque of 30 Nm which is greater than the temporary tightening torque of 2 Nm (step S24). Since the tightening-torque of the bolts 9a, 9b is about 40 Nm when the bolts 9a, 9b are fully tightened, the predetermined torque of 30 Nm is employed which is smaller than the torque of 40 Nm. The predetermined torque which is greater than the temporary tightening torque is selected depending on how well fragments are removed or the release of fragments is promoted, i.e., how well auxiliary cracks are developed to be able to remove fragments, or which process is used to brush the fractured surfaces.

Then, the bolts 9a, 9b are loosened by being reversed a predetermined angle, and a load state on the bolts 9a, 9b is detected when they are thus loosened (step S25). Specifically, it is confirmed whether contaminants, for example, are trapped between the externally threaded surfaces of the bolts 9a, 9b and the internally threaded surfaces of the bolt holes 42a, 42b or not. Contaminants can be confirmed as being trapped if more resistance is experienced in loosening the bolts 9a, 9b than usual, i.e., if the torque applied to loosen the bolts 9a, 9b is higher than a preset threshold value.

Contaminants are trapped when some threads of the externally threaded surfaces of the bolts 9a, 9b are broken or some threads of the internally threaded surfaces of the connecting rod 30 are broken.

If the torque applied to loosen the bolts 9a, 9b is not in excess of the preset threshold value, then the bolts 9a, 9b are judged as being tightened normally. The nut runners 336a, 336b are actuated to rotate the bolts 9a, 9b at the low speed in the normal direction. The bolts 9a, 9b are tightened until the tightening torque thereof reaches the snug torque of 19.6 Nm (step S26).

Finally, the bolts 9a, 9b are tightened by being turned 90 degrees (step S27).

According to the present embodiment, the bolts 9a, 9b are slowly tightened at the low speed to bring the fractured surfaces of the cap part 32 and the rod part 34 into contact with each other to align the irregularities of the fractured surfaces with each other. Therefore, the bolts 9a, 9b are tightened as if they are manually tightened by worker's fingers, so that a positional misalignment between the fractured surfaces due to the shrinkage of the cap part 32 at the time the connecting rod 30 is cracked is corrected.

According to the present embodiment, the temporary tightening torque is preset based on experimental data produced by measuring, with a torque wrench, the maximum torque of the bolts 9a, 9b that were manually tightened by worker's fingers. Tightening processes for the respective bolts 9a, 9b are equalized from the time (origin) when the tightening torque of the bolts 9a, 9b reaches the temporary tightening torque of 2 Nm. Then, from the temporary tightening torque of 2 Nm, the bolts 9a, 9b are tightened synchronously at the low speed for joining the cap part 32 and the rod part 34 to each other appropriately.

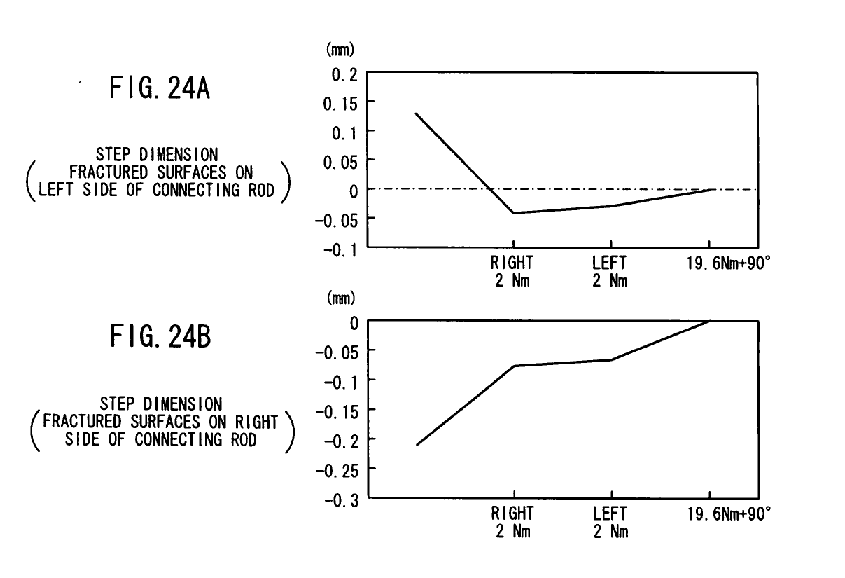

For example, as shown in FIG. 24A, when the left mating fractured surfaces are under the torque of 2 Nm (the right one of the mating fractured surfaces is under 2 Nm and the left one of the mating fractured surfaces is under 2 Nm), the dimension of the step between the mating fractured surfaces is not 0, and as shown in FIG. 24B, when the right mating fractured surfaces are under the torque of 2 Nm (the right one of the mating fractured surfaces is under 2 Nm and the left one of the mating fractured surfaces is under 2 Nm), the dimension of the step between the mating fractured surfaces is not 0.

Specifically, when the bolts 9a, 9b are temporarily tightened, the fractured surfaces of the cap part 32 and the rod part 34 are not fully coupled to each other, but a positional misalignment between the fractured surfaces is corrected and the fractured surfaces are aligned with each other. Then, the temporarily tightened bolts 9a, 9b are fully tightened in synchronism with each other.

According to the present embodiment, as a result, a positional misalignment between the mating fractured surfaces of the cap part 32 and the rod part 34 is corrected, allowing the mating fractured surfaces of the cap part 32 and the rod part 34 to self-fitted with respect to each other.

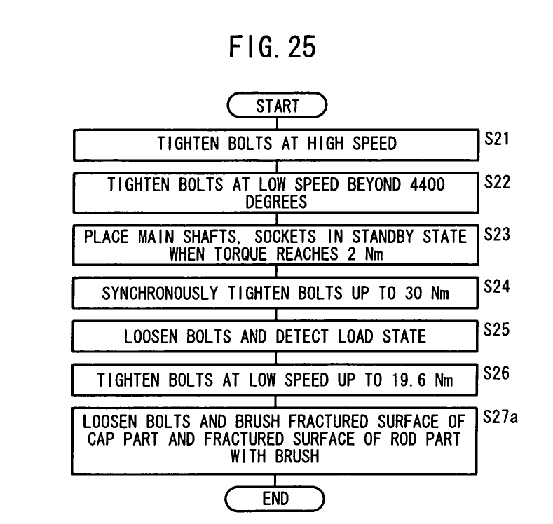

Tightening conditions according to another embodiment of the present invention for tightening the bolts 9a, 9b inserted into the bolt holes 42a, 42b while the fractured surfaces of the cap part 32 and the rod part 34 are being positioned with respect to each other, will be described in detail below with reference to a flowchart shown in FIG. 25. Steps S21 through S26 shown in FIG. 25 are identical to those for the tightening conditions described above, and will not be described in detail below.

After the bolts 9a, 9b are tightened until the tightening torque thereof reaches the snug torque of 19.6 Nm (step S26), the bolts 9a, 9b are loosened by being reversed, and fragments produced in the mating fractured surfaces of the cap part 32 and the rod part 34 are removed or the release of fragments produced in the mating fractured surfaces is promoted (step S27a).

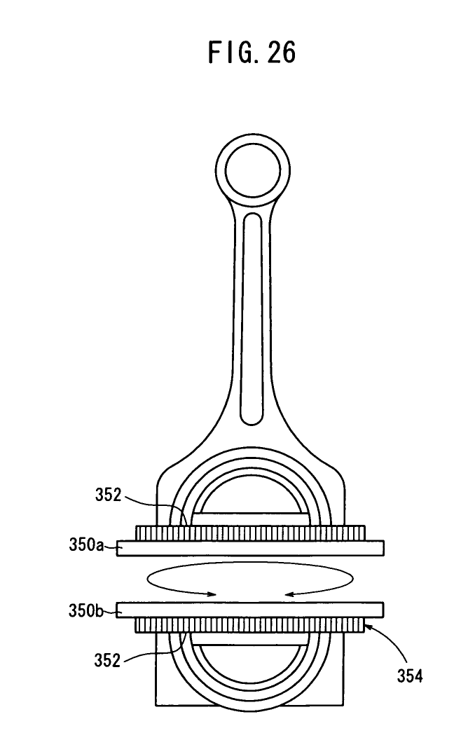

The fragments may be removed or the release of the fragments may be promoted as shown in FIG. 26. Specifically, a pair of brushes 354 having respective disks 350a, 350b with wires 352 of metal, e.g., SUS, attached to side surfaces thereof, may be employed, and the fractured surfaces of the cap part 32 and the rod part 34 may be brushed by the brushes 354 which may be rotated in a give direction.

The fractured surfaces of the cap part 32 and the rod part 34 may be brushed by the brushes 354 while the bolts 9a, 9b are inserted respectively in the bolt holes 42a, 42b and the fractured surfaces of the cap part 32 and the rod part 34 are spaced a certain distance from each other. Alternatively, the fractured surfaces of the cap part 32 and the rod part 34 may be brushed by the brushes 354 while the bolts 9a, 9b are removed respectively from the bolt holes 42a, 42b.

After the fragments have been removed or the release of the fragments has been promoted, the joining apparatus 300 is actuated to tighten the bolts 9a, 9b to the temporary tightening torque. Thereafter, the rotation of the bolts 9a, 9b is stopped, and then the bolts 9a, 9b are tightened synchronously to a predetermined torque greater than the temporary tightening torque.

Under the tightening conditions according to the other embodiment, the bolts 9a, 9b are slowly tightened at the low speed to bring the fractured surfaces of the cap part 32 and the rod part 34 into contact with each other to align the irregularities of the fractured surfaces with each other. Therefore, the bolts 9a, 9b are tightened as if they are manually tightened by worker's fingers, so that a positional misalignment between the fractured surfaces due to the shrinkage of the cap part 32 at the time the connecting rod 30 is cracked is corrected.

Under the tightening conditions according to the other embodiment, the temporary tightening torque is preset based on experimental data produced by measuring, with a torque wrench, the maximum torque of the bolts 9a, 9b that were manually tightened by worker's fingers. Tightening processes for the respective bolts 9a, 9b are equalized from the time (origin) when the tightening torque of the bolts 9a, 9b reaches the temporary tightening torque of 2 Nm. Then, from the temporary tightening torque of 2 Nm, the bolts 9a, 9b are tightened synchronously at the low speed for joining the cap part 32 and the rod part 34 to each other appropriately.

For example, as shown in FIG. 24A, when the left mating fractured surfaces are under the torque of 2 Nm (the right one of the mating fractured surfaces is under 2 Nm and the left one of the mating fractured surfaces is under 2 Nm), the dimension of the step between the mating fractured surfaces is not 0, and as shown in FIG. 24B, when the right mating fractured surfaces are under the torque of 2 Nm (the right one of the mating fractured surfaces is under 2 Nm and the left one of the mating fractured surfaces is under 2 Nm), the dimension of the step between the mating fractured surfaces is not 0.

Specifically, when the bolts 9a, 9b are temporarily tightened, the fractured surfaces of the cap part 32 and the rod part 34 are not fully coupled to each other, but a positional misalignment between the fractured surfaces is corrected and the fractured surfaces are aligned with each other. Then, the temporarily tightened bolts 9a, 9b are fully tightened in synchronism with each other.

Furthermore, under the tightening conditions according to the other embodiment, the fractured surface of the cap part 32 and the fractured surface of the rod part 34 are brought into contact with each other while they are being managed under a predetermined torque to remove fragments produced in the mating fractured surfaces of the cap part 32 and the rod part 34 or to promote the release of such fragments.

For example, as shown in FIGS. 13A through 13C, when the larger end 38 is fractured into the cap part 32 and the rod part 34, a main crack 200 is propagated to cause a brittle fracture. During the propagation of the main crack 200, the main crack 200 tends to branch into small auxiliary cracks 202. When the connecting rod 30 is assembled in an internal combustion engine or when the internal combustion engine incorporating the connecting rod 30 is operated, the auxiliary cracks 202 grow or are propagated together, giving rise to a region 204 where there is almost no contact between the fractured surface of the cap part 32 and the fractured surface of the rod part 34 (see FIG. 13B). The region 204 is so brittle that when a load (stress) is applied to the region 204, the region 204 comes off as a fragment, as shown in FIG. 13C.

Under the tightening conditions according to the other embodiment, the tightening torque for the bolts 9a, 9b that are used to combine the fractured surface of the cap part 32 and the fractured surface of the rod part 34 is managed. With the tightening torque being thus controlled, the fractured surface of the cap part 32 and the fractured surface of the rod part 34 are brought into contact with each other, and then brushed by the brushes 354 to remove fragments produced in the fractured surfaces or promote the release of such fragments.

As described above, under the tightening conditions according to the other embodiment, the tightening torque for the bolts 9a, 9b that are used to bring the fractured surface of the cap part 32 and the fractured surface of the rod part 34 into contact with each other is managed. With the tightening torque being thus controlled, the fractured surface of the cap part 32 and the fractured surface of the rod part 34 are brought into contact with each other, and then brushed by the brushes 354. Therefore, even if fragments are produced in the fractured surfaces, the fragments can be removed or the release of such fragments can be promoted.

The process of removing fragments produced in the fractured surfaces or promoting the release of such fragments is not limited to the brushing by the brushes 354. Fragments produced in the fractured surfaces may alternatively be removed by an adhesive tape, a suction machine, or a vibrator. Specifically, if an adhesive tape is used, then the adhesive tape is applied to the fractured surfaces and then peeled off from the fractured surfaces to remove fragments from the fractured surfaces. If a suction machine is used, then a negative pressure is applied by the suction machine to the fractured surfaces to remove fragments from the fractured surfaces. In either case, the fragments can reliably be removed from the fractured surfaces or the release of such fragments can reliably be promoted.

After the fragments have been removed or the release of the fragments has been promoted, the mating fractured surfaces of the cap part 32 and the rod part 34 are separated from each other, allowing the fragments to be released smoothly from the fractured surfaces.

Under the tightening conditions according to the other embodiment, as a result, a positional misalignment between the mating fractured surfaces of the cap part 32 and the rod part 34 is corrected, allowing the mating fractured surfaces of the cap part 32 and the rod part 34 to self-fitted with respect to each other. In addition, fragments produced in the mating fractured surfaces can smoothly be removed or the release of such fragments can smoothly be promoted, without impairing the configurations of the fractured surfaces.

Although certain preferred embodiments of the present invention have been shown and described in detail, it should be understood that various changes and modifications may be made therein without departing from the scope of the appended claims.

1. An apparatus for manufacturing a connecting rod by integrally forming a connecting rod having a larger end and a smaller end, setting a joint hole in the larger end over a pair of spreaders, and spreading the spreaders apart from each other to crack the larger end into a cap part and a rod part, comprising:
a workpiece positioning and holding mechanism having a fixed stage (62) fixedly mounted on a base and a movable stage disposed in facing relation to said fixed stage and horizontally movable toward and away from said fixed stage, said workpiece positioning and holding mechanism being arranged to set said connecting rod positioned at a predetermined position with one of said spreaders near said rod part which is fixed to said fixed stage and the other spreader near said cap part which is displaceable in unison with said movable stage, and to hold said connecting rod thus set;
a loading mechanism for applying a fracture load in a direction to move said one of the spreaders and the other spreader away from each other to crack said larger end; and
a fragment removing/release promoting mechanism for displacing said movable stage toward said fixed stage while said cap part and said rod part are being held respectively on said movable stage and said fixed stage after said larger end is cracked into said cap part and said rod part, to bring a fractured surface of said cap part and a fractured surface of said rod part into contact with each other for removing fragments produced in the fractured surfaces or promoting a release of fragments produced in the fractured surfaces.

2. An apparatus according to claim 1, wherein said workpiece positioning and holding mechanism comprises:
a first support mechanism for pressing shoulders of said larger end near said cap part toward said smaller ends; and
a second support mechanism for pressing downwardly an end of said first support mechanism which is remote from an opposite end thereof which engages said connecting rod, thereby to clamp said first support mechanism;
said first support mechanism and said second support mechanism being fixed to said movable stage for displacement in unison with said movable stage.

3. An apparatus according to claim 2, wherein said second support mechanism comprises:
a cylinder having a piston and a piston rod connected thereto; and
a block connected to a distal end of said piston rod, said block having a pressing surface engaging a slanted surface of said first support mechanism at said end thereof.

4. An apparatus according to claim 1, further comprising:
a preload applying mechanism for applying a preload in a direction to space said spreaders away from each other to press said spreaders against an inner surface of said larger end which defines a joint hole therein;
wherein after said preload is applied by said preload applying mechanism, said second support mechanism is actuated to clamp said first support mechanism.

5. An apparatus according to claim 1, wherein said loading mechanism comprises:
a wedge for being pressed into between said spreaders; and
a single actuator for pulling said wedge downwardly between said spreaders.

6. An apparatus according to claim 1, wherein said workpiece positioning and holding mechanism comprises:
a first workpiece support member disposed on said fixed stage for engaging the smaller end of said connecting rod and pressing said smaller end axially toward said larger end; and
a cylinder for moving said first workpiece support member toward and away from said smaller end.

7. An apparatus according to claim 6, wherein said first workpiece support member has an engaging portion on an end thereof for engaging the smaller end of said connecting rod.

8. An apparatus according to claim 1, wherein said workpiece positioning and holding mechanism comprises:
a second workpiece support member disposed on said fixed stage for pressing downwardly an upper surface of the larger end of said connecting rod; and
a cylinder for angularly moving said second workpiece support member through a predetermined angle about a pin.

9. An apparatus according to claim 1, wherein said fragment removing/release promoting mechanism comprises:
a pair of backup cylinders fixed to a side wall of a bracket joined to said base, for displacing said movable stage in axial directions of said connecting rod.

10. A method of manufacturing a connecting rod by integrally forming a connecting rod having a larger end and a smaller end, setting a joint hole in the larger end over a pair of spreaders, and spreading the spreaders apart from each other to crack the larger end into a cap part and a rod part, comprising the steps of:
setting the rod part of said connecting rod on a fixed stage and setting the cap part of said connecting rod on a movable stage which is movable with respect to said fixed stage;
pressing said cap part toward said smaller end with a first support mechanism to laterally support shoulders of said cap part;
actuating a second support mechanism to press said first support mechanism toward said cap part thereby to secure said cap part between said first support mechanism and one of said spreaders which is positioned near said cap part;
applying a load to said spreaders to crack said larger end into said cap part and said rod part while said cap part is being displaced in unison with said movable stage with said cap part being secured between said first support mechanism and said one of the spreaders which is positioned near said cap part; and
displacing said movable stage toward said fixed stage while said cap part and said rod part are being held respectively on said movable stage and said fixed stage after said larger end is cracked into said cap part and said rod part, to bring a fractured surface of said cap part and a fractured surface of said rod part into contact with each other for removing fragments produced in the fractured surfaces or promoting a release of fragments produced in the fractured surfaces.

11. A method according to claim 10, wherein after applying a preload to said spreaders with a preload applying mechanism, said second support mechanism is actuated to secure said cap part between said first support mechanism and said one of the spreaders which is positioned near said cap part.

12. A method according to claim 10, wherein after said cap part is secured between said first support mechanism and said one of the spreaders which is positioned near said cap part, a fracture load is applied to a wedge to press said wedge into between said spreaders, only by an actuator for pulling said wedge.

13. A method according to claim 10, wherein said movable stage is displaced toward said fixed stage by a fragment removing/release promoting mechanism comprising a pair of backup cylinders fixed to a side wall of a bracket joined to said base, for displacing said movable stage in axial directions of said connecting rod, said backup cylinders being substantially simultaneously actuatable to displace said cap part in unison with said movable stage to bring said fractured surface of said cap part into contact with said fractured surface of said rod part which is held by said fixed stage.

14. A method according to claim 10, wherein after said fractured surface of said cap part and said fractured surface of said rod part are brought into contact with each other, a thrust force applied to said fractured surfaces of said cap part and said rod part is changed to an increased level to remove the fragments produced in the fractured surfaces or promote the release of the fragments produced in the fractured surfaces.

15. A method of manufacturing a connecting rod by integrally forming a connecting rod having a larger end and a smaller end, cracking said connecting rod into a cap part and a rod part, and thereafter fastening said cap part and said rod part together with a pair of bolts with a fractured surface of said cap part and a fractured surface of said rod part mating with each other, comprising the steps of:
rotating said bolts to move said fractured surface of said cap part and said fractured surface of said rod part toward each other, bringing said fractured surface of said cap part and said fractured surface of said rod part into contact with each other such that irregularities of said fractured surface of said cap part and said fractured surface of said rod part are complementarily aligned with each other, and stopping rotating said bolts and holding said bolts in a standby state when a tightening torque of said bolts which are tightened by being rotated reaches a temporary tightening torque predetermined based on experimental data; and
tightening said bolts in synchronism with each other until the tightening torque of said bolts reach a predetermined torque which is greater than said temporary tightening torque.

16. A method according to claim 15, wherein said temporary tightening torque comprises a torque corresponding to a torque produced when said bolts are tightened by fingers.

17. A method according to claim 15, wherein after said bolts are tightened in synchronism with each other until the tightening torque of said bolts reaches a predetermined torque which is greater than said temporary tightening torque, said bolts are loosened to remove fragments produced in the fractured surface of said cap part and the fractured surface of said rod part or promote the release of fragments produced in the fractured surface of said cap part and the fractured surface of said rod part.

18. A method according to claim 17, wherein the fragments are removed or the release of the fragments is promoted by brushing the fractured surface of said cap part and the fractured surface of said rod part.

19. A method according to claim 17, further comprising the steps of
after the fragments are removed or the release of the fragments is promoted, tightening said bolts to the temporary tightening torque, stopping rotating said bolts and holding said bolts in a standby state, and tightening said bolts in synchronism with each other until the tightening torque of said bolts reaches a predetermined torque which is greater than said temporary tightening torque.
